(19) United States
(12) Patent Application Publication
(10) Pub. No.: US 2021/0006836 A1
(43) Pub. Date: Jan. 7, 2021

(54) IMAGE ENCODING APPARATUS, IMAGE ENCODING METHOD, IMAGE DECODING APPARATUS, AND IMAGE DECODING METHOD

(71) Applicant: SONY CORPORATION, TOKYO (JP)

(72) Inventor: KENJI KONDO, TOKYO (JP)

(21) Appl. No.: 17/040,763

(22) PCT Filed: Mar. 18, 2019
(86) PCT No.: PCT/JP2019/011047

§ 371 Date: Sep. 23, 2020

(30) Foreign Application Priority Data
Mar. 30, 2018 (JP) 2018-068856

(51) Int. Cl. H04N 19/60; H04N 19/12; H04N 19/17; H04N 19/18; H04N 19/70

(52) U.S. Cl. CPC H04N 19/60; H04N 19/12; H04N 19/70; H04N 19/18; H04N 19/17

(57) ABSTRACT

The present disclosure relates to an image encoding apparatus, an image encoding method, an image decoding apparatus, and an image decoding method that are capable of reducing the processing amounts of encoding and decoding. In the encoding apparatus, identification information for identifying a threshold of an orthogonal transformation maximum size is set. In a case where a coding unit is larger than the threshold of the orthogonal transformation maximum size, simple orthogonal transformation is performed on the coding unit. A simple transformation coefficient that is a result of the simple orthogonal transformation is encoded so that a bitstream including the identification information is generated. In the image decoding apparatus, identification information is parsed from a bitstream. The bitstream is decoded so that a simple transformation coefficient that is a result of simple orthogonal transformation on a coding unit is generated. Simple inverse orthogonal transformation based on a size of the coding unit is performed by referring to the identification information. The present technology is applicable to, for example, an image encoding apparatus configured to encode images and an image decoding apparatus configured to decode images.

### TECHNICAL FIELD

The present disclosure relates to an image encoding apparatus, an image encoding method, an image decoding apparatus, and an image decoding method, and in particular, to an image encoding apparatus, an image encoding method, an image decoding apparatus, and an image decoding method that are capable of reducing the processing amounts of encoding and decoding.

### BACKGROUND ART

The JVET (Joint Video Exploration Team) searching for a next generation video coding of ITU-T (International Telecommunication Union Telecommunication Standardization Sector) has proposed inter prediction (Affine motion compensation (MC) prediction) that performs motion compensation with affine transformation of a reference image, based on motion vectors of vertices of a subblock (for example, see NPL 1). With such inter prediction, not only translation between screens (parallel movement), but also more complex movements such as rotation, scaling, and skew can be predicted. The coding efficiency is expected to improve as the quality of the prediction is improved.

### CITATION LIST

### Non Patent Literature

[NPL 1]
Jianle Chen, Elena Alshina, Gary J. Sullivan, Jens-Rainer, JillBoyce, “Algorithm Description of Joint Exploration Test Model 4,” JVET-G1001_v1, Joint Video Exploration Team (JVET) of ITU-T SG 16 WP 3 and ISO/IEC JTC 1/SC 29/WG 11 7th Meeting: Torino, IT, 13-21 Jul. 2017

### SUMMARY

### Technical Problem

Incidentally, applying the above-mentioned affine transformation to perform inter prediction not only improves the quality of prediction but also enhances the coding efficiency with a coding unit having a large size as a result of the code amount being large in affine transformation. However, it is concerned that, when the size of a coding unit is increased, the processing amounts of, for example, orthogonal transformation and inverse orthogonal transformation in encoding and decoding are increased.

The present disclosure has been made in view of such circumstances and achieves a reduction in the processing amounts of encoding and decoding.

According to a first aspect of the present disclosure, there is provided an image encoding apparatus including a setting section configured to set identification information for identifying a threshold of an orthogonal transformation maximum size that is a maximum size of a processing unit in orthogonal transformation of an image, an orthogonal transformation section configured to perform, in a case where a coding unit that is a processing unit in encoding of the image is larger than the threshold of the orthogonal transformation maximum size, simple orthogonal transformation on the coding unit, and an encoding section configured to encode a simple transformation coefficient obtained as a result of the simple orthogonal transformation by the orthogonal transformation section, to thereby generate a bitstream including the identification information.

According to the first aspect of the present disclosure, there is provided an image encoding method including, by an encoding apparatus configured to encode an image, setting identification information for identifying a threshold of an orthogonal transformation maximum size hat is a maximum size of a processing unit in orthogonal transformation of the image, performing, in a case where a coding unit that is a processing unit in encoding of the image is larger than the threshold of the orthogonal transformation maximum size, simple orthogonal transformation on the coding unit, and encoding a simple transformation coefficient that is a result of the simple orthogonal transformation, to thereby generate a bitstream including the identification information.

In the first aspect of the present disclosure, identification information for identifying a threshold of an orthogonal transformation maximum size that is a maximum size of a processing unit in orthogonal transformation of an image is set. In a case where a coding unit that is a processing unit in encoding of the image is larger than the threshold of the orthogonal transformation maximum size, simple orthogonal transformation is performed on the coding unit. A simple transformation coefficient obtained as a result of the simple orthogonal transformation is encoded so that a bitstream including the identification information is generated.

According to a second aspect of the present disclosure, there is provided an image decoding apparatus including a parsing section configured to parse, from a bitstream including identification information for identifying a threshold of an orthogonal transformation maximum size that is a maximum size of a processing unit in orthogonal transformation of an image, the identification information, a decoding section configured to decode the bitstream to generate a simple transformation coefficient that is a result of simple orthogonal transformation on a coding unit that is a processing unit in encoding of the image, and an inverse orthogonal transformation section configured to perform simple inverse orthogonal transformation, based on a size of the coding unit by referring to the identification information parsed by the parsing section.

According to the second aspect of the present disclosure, there is provided an image decoding method including, by a decoding apparatus configured to decode an image, parsing, from a bitstream including identification information for identifying a threshold of an orthogonal transformation maximum size that is a maximum size of a processing unit in orthogonal transformation of the image, the identification information, decoding the bitstream to generate a simple transformation coefficient that is a result of simple orthogonal transformation on a coding unit that is a processing unit in encoding of the image, and performing simple inverse orthogonal transformation based on a size of the coding unit by referring to the identification information parsed.

In the second aspect of the present disclosure, from a bitstream including identification information for identifying a threshold of an orthogonal transformation maximum size that is a maximum size of a processing unit in orthogonal transformation of an image, the identification information is parsed. The bitstream is decoded so that a simple transformation coefficient that is a result of simple orthogonal transformation on a coding unit that is a processing unit in encoding of the image is generated. Simple inverse orthogonal transformation based on a size of the coding unit is performed by referring to the identification information parsed.

### Advantageous Effect of Invention

According to the first and second aspects of the present disclosure, it is possible to reduce the processing amounts of encoding and decoding.

Note that, the effect described here is not necessarily limited and may be any effect described in the present disclosure.

### BRIEF DESCRIPTION OF DRAWINGS

FIG. 1 is a block diagram illustrating a configuration example of one embodiment of an image transmission system to which the present technology is applied.

FIG. 2 is a diagram illustrating processing that is performed in an encoding circuit.

FIG. 3 is a diagram illustrating processing that is performed in a decoding circuit.

FIG. 4 is a block diagram illustrating a configuration example of one embodiment of an image encoding apparatus.

FIG. 5 is a block diagram illustrating a configuration example of one embodiment of an image decoding apparatus.

FIG. 6 is a flowchart illustrating image encoding.

FIG. 7 is a flowchart illustrating a first processing example of processing in a case where simple orthogonal transformation is performed.

FIG. 8 is a flowchart illustrating a second processing example of processing in the case where simple orthogonal transformation is performed.

FIG. 9 is a flowchart illustrating a third processing example of processing in the case where simple orthogonal transformation is performed.

FIG. 10 is a flowchart illustrating image decoding.

FIG. 11 is a flowchart illustrating a first processing example of processing in a case where simple inverse orthogonal transformation is performed.

FIG. 12 is a flowchart illustrating a second processing example of processing in the case where simple inverse orthogonal transformation is performed.

FIG. 13 is a flowchart illustrating a third processing example of processing in the case where simple inverse orthogonal transformation is performed.

FIG. 14 is a block diagram illustrating a configuration example of one embodiment of a computer to which the present technology is applied.

### DESCRIPTION OF EMBODIMENTS

<Documents Etc. That Support Technical Contents and Technical Terms>

The scope disclosed by the present technology includes not only the contents described in embodiments but also the contents described in the following pieces of NPL well known at the time of the filing of the subject application.
NPL 1: (described above)
NPL 2: TELECOMMUNICATION STANDARDIZATION SECTOR OF ITU (International Telecommunication Union), “High efficiency video coding,” H.265, 12/2016
NPL 3: TELECOMMUNICATION STANDARDIZATION SECTOR OF ITU (International Telecommunication Union), “Advanced video coding for generic audiovisual services,” H.264, 04/2017

That is, the contents described in NPL 1 to NPL 3 described above also serve as the bases for determining the support requirements. For example, even in a case where the QTBT (Quad Tree Plus Binary Tree) Block Structure described in NPL 1 or the QT (Quad-Tree) Block Structure described in NPL 2 are not directly described in the embodiments, such structures are within the scope of disclosure of the present technology and satisfy the support requirements of the scope of the claims. Further, in a similar manner, even in a case where technical terms, for example, parsing, syntax, and semantics, are not directly described in the embodiments, such technical terms are within the scope of disclosure of the present technology and satisfy the support requirements of the scope of the claims.

### Terms

In the subject application, the following terms are defined as follows.

<Block>

Unless otherwise stated, a “block” described as a partial region of an image (picture) or a processing unit (not a block representing a processing section) represents a certain partial region in the picture, and the size, shape, characteristics, and the like of the block are not limited. For example, the “block” includes any partial region (processing unit) such as TB (Transform Block), TU (Transform Unit), PB (Prediction Block), PU (Prediction Unit), SCU (Smallest Coding Unit), CU (Coding Unit), LCU (Largest Coding Unit), CTB (Coding TreeBlock), CTU (Coding Tree Unit), a transformation block, a subblock, a macroblock, a tile, or a slice.

<Specification of Block Size>

Further, when the size of such a block is to be specified, the block size may be specified indirectly instead of being specified directly. For example, a block size may be specified with the use of identification information for identifying the size. Further, for example, a block size may be specified from a ratio or difference with respect to the size of a block serving as a reference (for example, LCU or SCU). For example, in a case where information for specifying a block size is transmitted as a syntax element or the like, information for indirectly specifying the size as described above may be used as the first-mentioned information. With this, the information amount of such information can be reduced, and the coding efficiency can be enhanced in some cases. Further, specifying a block size also includes specifying the range of a block size (for example, specifying the range of an allowable block size).

<Information and Processing Unit>

Various types of information are set in any data unit, and various types of processing are performed on data in any unit; the examples described above are not limitative. For example, the information or the processing may be set for each TU (Transform Unit), TB (Transform Block), PU (Prediction Unit), PB (Prediction Block), CU (Coding Unit), LCU (Largest Coding Unit), a subblock, a block, a tile, a slice, a picture, a sequence, or a component or may be used for data in such a data unit. Needless to say, this data unit may be set for each piece of information or processing, and all pieces of information or processing are not required to be set in the same data unit. Note that, the information is stored in a freely-selected place and may be stored in a header, a parameter set, or the like in the above-mentioned data unit. Further, the information may be stored in a plurality of places.

<Control Information>

Control information associated with the present technology may be transmitted from the encoding side to the decoding side. For example, control information for controlling whether or not to permit (or prohibit) the application of the present technology described above (for example, enabled_flag) may be transmitted. Further, for example, control information for indicating an object to which the present technology described above is to be applied (or an object to which the present technology is not to be applied) may be transmitted. For example, control information for specifying a block size (an upper limit, a lower limit, or both the limits), a frame, a component, a layer, or the like that is compatible with the application of the present technology (or permits or prohibits the application) may be transmitted.

<Flag>

Note that, a “flag” herein is information for identifying a plurality of states and includes not only information used to identify two states of true (1) and false (0) but also information that allows the identification of three or more states. Thus, the possible values of the “flag” may, for example, be two values of 1/0 or three or more values. That is, the “flag” has any number of bits and may have one bit or a plurality of bits. Further, as for identification information (including a flag), the identification information may be included in a bitstream, or difference information regarding the identification information with respect to information serving as a reference may be included in the bitstream. Thus, the “flag” and the “identification information” herein include not only information regarding the “flag” or the “identification information,” but also difference information with respect to information serving as a reference.

<Association of Metadata>

Further, various types of information regarding encoded data (bitstream) (such as metadata) may be transmitted or recorded in any form as long as the information is associated with the encoded data. Here, the term “associate” means, for example, that one piece of data may be used (may be linked) during the processing of another piece of data. That is, pieces of data associated with each other may be integrated as one piece of data or provided as separate pieces of data. For example, information associated with encoded data (image) may be transmitted on a transmission path different from the one for the encoded data (image). Further, for example, information associated with encoded data (image) may be recorded on a recording medium different from the one for the encoded data (image) (or in a different recording area of the same recording medium). Note that, data may be “associated” with each other partly, rather than entirely. For example, an image and information corresponding to the image may be associated with each other in any unit, such as a plurality of frames, one frame, or part of a frame.

Note that, the terms, such as “combine,” “multiplex,” “add,” “integrate,” “include,” “store,” “put in,” “place into,” and “insert,” herein each mean grouping a plurality of things, for example, grouping encoded data and metadata. The terms each mean one method of “associate” described above. Further, herein, encoding includes not only the entire processing of transforming an image into a bitstream but also part of the processing. For example, encoding includes not only processing including prediction, orthogonal transformation, quantization, arithmetic coding, and the like but also processing that is a collective term for quantization and arithmetic coding, processing including prediction, quantization, and arithmetic coding, and the like. Similarly, decoding includes not only the entire processing of transforming a bitstream into an image but also part of the processing. For example, decoding includes not only processing including inverse arithmetic decoding, inverse quantization, inverse orthogonal transformation, prediction, and the like but also processing including inverse arithmetic decoding and inverse quantization, processing including inverse arithmetic decoding, inverse quantization, and prediction, and the like.

Now, specific embodiments to which the present technology is applied are described in detail with reference to the drawings.

<Outline of Present Technology>

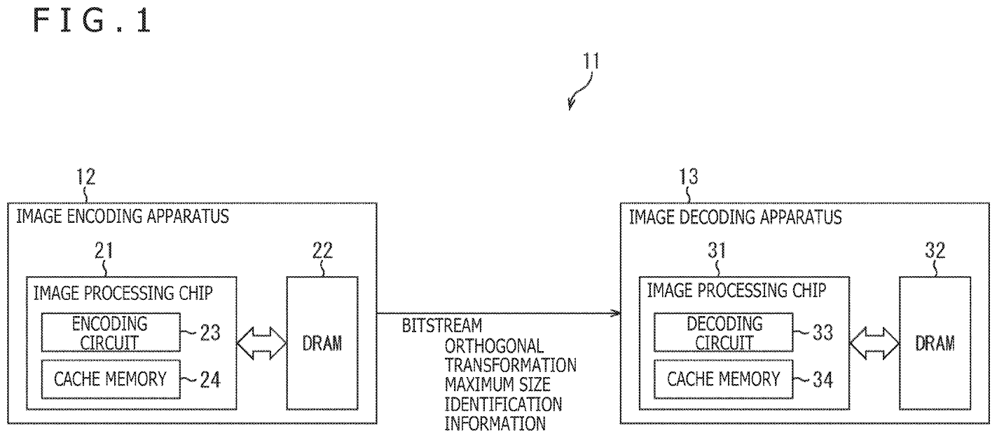

With reference to FIG. 1 to FIG. 5, the outline of the present technology is described.

FIG. 1 is a block diagram illustrating a configuration example of one embodiment of an image processing system to which the present technology is applied.

As illustrated in FIG. 1, an image processing system 11 includes an image encoding apparatus 12 and an image decoding apparatus 13. For example, in the image processing system 11, an image taken by an unillustrated imaging apparatus is input to the image encoding apparatus 12, and the image is encoded in the image encoding apparatus 12, with the result that encoded data is generated. With this, in the image processing system 11, the encoded data is transmitted from the image encoding apparatus 12 to the image decoding apparatus 13 as a bitstream. Then, in the image processing system 11, the encoded data is decoded in the image decoding apparatus 13 so that an image is generated. The image is displayed on an unillustrated display apparatus.

The image encoding apparatus 12 includes an image processing chip 21 and an external memory 22 connected to each other via a bus.

The image processing chip 21 includes an encoding circuit 23 configured to encode images and a cache memory 24 configured to temporarily store data that the encoding circuit 23 needs when encoding images.

The external memory 22 includes, for example, a DRAM (Dynamic Random Access Memory) and stores, in processing units in processing in the image processing chip 21 (for example, frame), the data of images to be encoded in the image encoding apparatus 12. Note that, in a case where the QTBT (Quad Tree Plus Binary Tree) Block Structure described in NPL 1 or the QT (Quad-Tree) Block Structure described in NPL 2 is applied as the block structure, CTB (Coding TreeBlock), CTU (Coding Tree Unit), PB (Prediction Block), PU (Prediction Unit), CU (Coding Unit), or CB (Coding Block) may be stored in the external memory 22 as a processing unit. CTB or CTU, which is a processing unit that fixes block sizes at the sequence level, is preferably used as the processing unit.

For example, in the image encoding apparatus 12, of the data of images for one frame (or CTB) stored in the external memory 22, data divided in coding units that correspond to a processing unit in encoding is read to the cache memory 24. Then, in the image encoding apparatus 12, the encoding circuit 23 performs encoding in coding units stored in the cache memory 24 to generate encoded data. Note that, here, the case where the blocks of CUs and TUs are processed in the same dimension is described, but the blocks of CUs and TUs may be processed in different dimensions like QT.

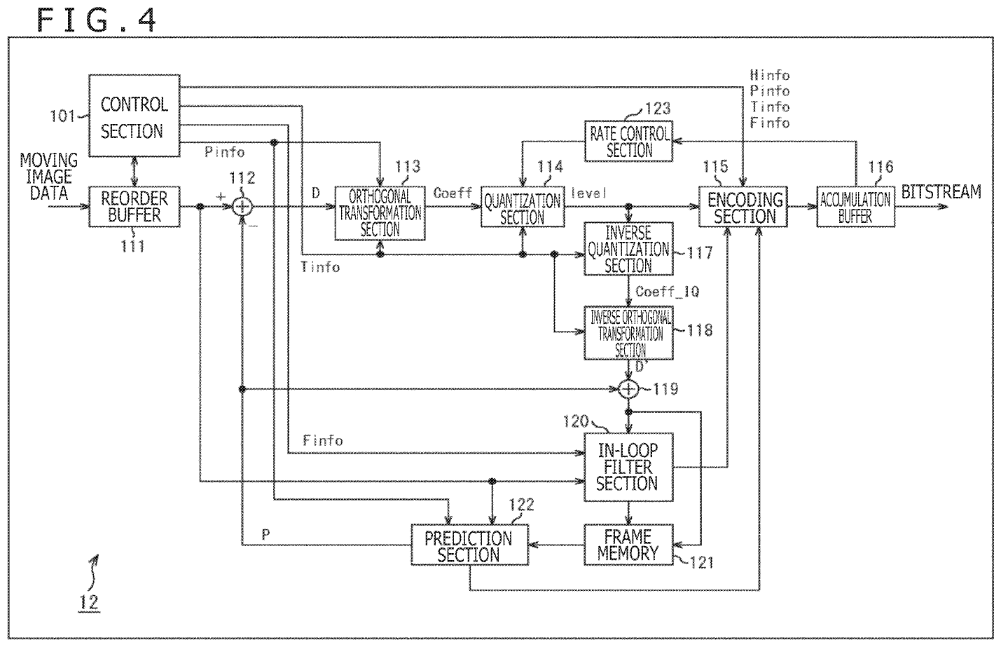

Here, in the image encoding apparatus 12, when the encoded data is generated, as described later with reference to FIG. 4, orthogonal transformation is performed on a predicted residual D on the basis of transformation information Tinfo, and a transformation coefficient Coeff is generated as a result of the orthogonal transformation. For example, this orthogonal transformation is also performed in processing units that correspond to the coding unit. Thus, in the image encoding apparatus 12, a threshold of an orthogonal transformation maximum size that is the maximum size of processing units in orthogonal transformation is set. In a case where a coding unit is larger than the threshold of the orthogonal transformation maximum size, simple orthogonal transformation that is processing simpler than orthogonal transformation is performed instead of normal orthogonal transformation. For example, simple orthogonal transformation includes skipping the output of residual data, skipping orthogonal transformation, and generating only a direct-current component as residual data. Further, when simple orthogonal transformation is performed, a simple transformation coefficient including no residual data, a simple transformation coefficient including residual data in the spatial domain, or a simple transformation coefficient including only a direct-current component as residual data is obtained. Note that, again, the case where the blocks of CUs and TUs are processed in the same dimension is described, but the blocks of CUs and TUs may be processed in different dimensions like QT.

Then, in the image processing system 11, the bitstream including orthogonal transformation maximum size identification information for identifying the threshold of the orthogonal transformation maximum size is transmitted from the image encoding apparatus 12 to the image decoding apparatus 13. Note that, the orthogonal transformation maximum size identification information may be in any expression form as long as the information is capable of identifying the threshold of the maximum size or shape of orthogonal transformation.

The image decoding apparatus 13 includes an image processing chip 31 and an external memory 32 connected to each other via a bus.

The image processing chip 31 includes a decoding circuit 33 configured to generate images by decoding encoded data and a cache memory 34 configured to temporarily store data that the decoding circuit 33 needs when decoding encoded data.

The external memory 32 includes, for example, a DRAM and stores encoded data to be decoded in the image decoding apparatus 13 in image processing units (for example, frame or CTB).

For example, in the image decoding apparatus 13, the orthogonal transformation maximum size identification information is parsed from the bitstream, and orthogonal transformation or simple orthogonal transformation is performed on the basis of the size of the coding unit by reference to the orthogonal transformation maximum size identification information. Then, in the image decoding apparatus 13, the encoded data is decoded by the decoding circuit 33 in coding units stored in the cache memory 34 so that an image is generated.

In such way, in the image encoding apparatus 12 of the image processing system 11, orthogonal transformation maximum size identification information for identifying a threshold of an orthogonal transformation maximum size is set, and a bitstream including subblock size identification information is transmitted to the image decoding apparatus 13. For example, in the image processing system 11, orthogonal transformation maximum size identification information can be defined by high-level syntax such as SPS, PPS, or SLICE header. For example, in view of simplification of processing and parsing in the image decoding apparatus 13, orthogonal transformation maximum size identification information is preferably defined by SPS or PPS.

Then, in the image processing system 11, a coding unit larger than the threshold of the orthogonal transformation maximum size is subjected to simple orthogonal transformation, with the result that the processing amounts of encoding and decoding can be reduced. Thus, for example, for an application demanded to be executed with a reduced processing amount, a small threshold is set for the orthogonal transformation maximum size so that the processing amounts of encoding and decoding can greatly be reduced, with the result that encoding or decoding can be performed more reliably.

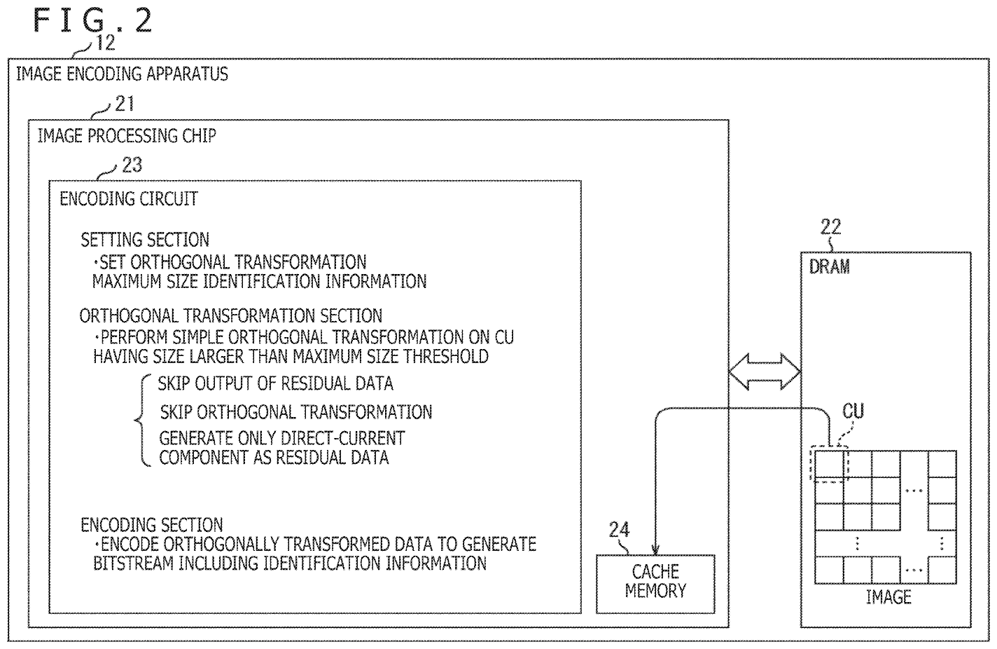

With reference to FIG. 2, the processing that is performed by the encoding circuit 23 of the image encoding apparatus 12 is further described.

For example, the encoding circuit 23 is designed to function as a setting section, an orthogonal transformation section, and an encoding section as illustrated in FIG. 2.

Specifically, the encoding circuit 23 can perform the setting processing of setting orthogonal transformation maximum size identification information for identifying a threshold of an orthogonal transformation maximum size.

Here, in a case where, for example, a processing amount required for an application for executing image encoding in the image encoding apparatus 12 is equal to or less than a predetermined setting value, the encoding circuit 23 sets the orthogonal transformation maximum size identification information so that the threshold of the orthogonal transformation maximum size takes a small value. In a similar manner, in a case where, for example, a processing amount required for an application for executing bitstream decoding in the image decoding apparatus 13 is equal to or less than a predetermined setting value, the encoding circuit 23 sets the orthogonal transformation maximum size identification information so that the threshold of the orthogonal transformation maximum size takes a small value. Here, to the image encoding apparatus 12 and the image decoding apparatus 13, the setting values for defining the processing amounts for applications to be executed are set in advance depending on the processing capabilities. For example, in a case where a mobile terminal having a low processing capability performs encoding or decoding, a low setting value depending on the processing capability is set.

Moreover, in a case where the size of a coding unit is larger than the threshold of the orthogonal transformation maximum size, the encoding circuit 23 can perform simple orthogonal transformation on the coding unit instead of normal orthogonal transformation.

Here, in the simple orthogonal transformation, the encoding circuit 23 does not perform orthogonal transformation on the coding unit having the size larger than the threshold of the orthogonal transformation maximum size and skips the output of residual data per se (for example, does not perform supply to the quantization section 114 illustrated in FIG. 4). That is, in this simple orthogonal transformation, a simple transformation coefficient obtained by performing simple orthogonal transformation on the coding unit includes no residual data.

Alternatively, in the simple orthogonal transformation, the encoding circuit 23 skips orthogonal transformation on the coding unit having the size larger than the threshold of the orthogonal transformation maximum size and outputs residual data in the spatial domain not subjected to orthogonal transformation. That is, in this simple orthogonal transformation, a simple transformation coefficient obtained by performing simple orthogonal transformation on the coding unit includes the residual data in the spatial domain.

Alternatively, in the simple orthogonal transformation, the encoding circuit 23 performs orthogonal transformation on the coding unit having the size larger than the threshold of the orthogonal transformation maximum size but generates only a direct-current component as residual data, to output the direct-current component. That is, in this simple orthogonal transformation, a simple transformation coefficient obtained by performing simple orthogonal transformation on the coding unit includes only the direct-current component serving as the residual data.

In such way, as a result of orthogonal transformation or simple orthogonal transformation in the encoding circuit 23, the transformation coefficient generated by performing normal orthogonal transformation is obtained, or the simple transformation coefficient obtained by simple orthogonal transformation includes the residual data in the spatial domain or the direct-current component serving as the residual data. Note that, the simple transformation coefficient obtained by simple orthogonal transformation is not required to include residual data.

Moreover, the encoding circuit 23 can perform the encoding processing of encoding the transformation coefficient or the simple transformation coefficient (the residual data in the spatial domain or the direct-current component serving as the residual data) obtained by orthogonal transformation or simple orthogonal transformation and generating a bitstream including the orthogonal transformation maximum size identification information.

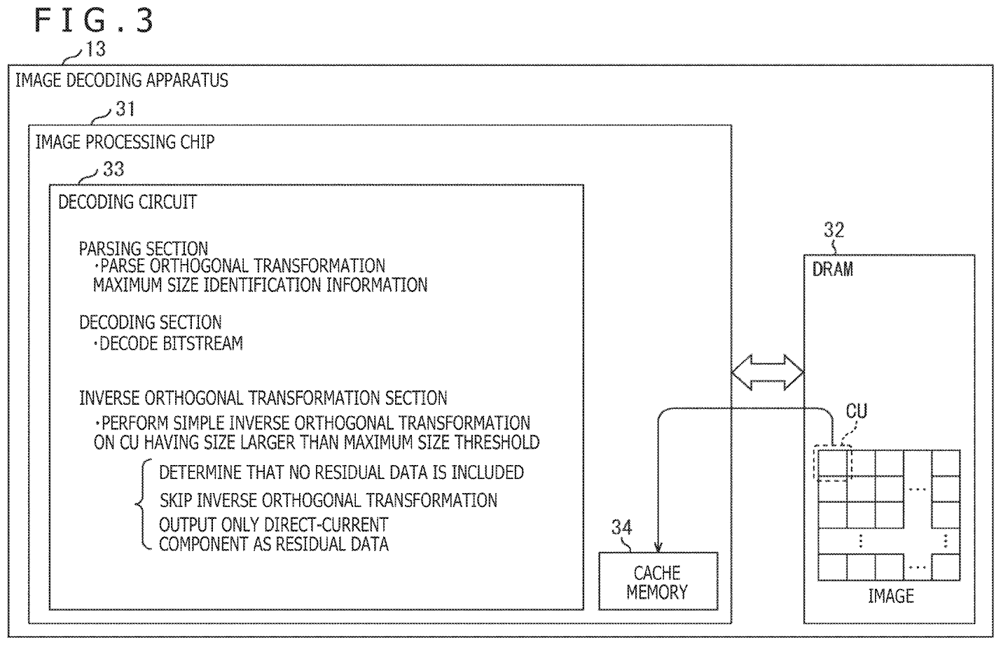

With reference to FIG. 3, the processing that is performed by the decoding circuit 33 of the image decoding apparatus 13 is further described.

For example, the decoding circuit 33 is designed to function as a parsing section, a decoding section, and an inverse orthogonal transformation section as illustrated in FIG. 3.

Specifically, the decoding circuit 33 can perform the parse processing of parsing, from a bitstream transmitted from the image encoding apparatus 12, orthogonal transformation maximum size identification information for identifying a threshold of an orthogonal transformation maximum size.

Further, the decoding circuit 33 can perform the decoding processing of decoding the bitstream and generating a transformation coefficient or simple transformation coefficient obtained as a result of orthogonal transformation or simple orthogonal transformation in the encoding circuit 23.

Then, the decoding circuit 33 can perform, in a case where the size of a coding unit is larger than the threshold of the orthogonal transformation maximum size, simple inverse orthogonal transformation on the coding unit instead of normal inverse orthogonal transformation, by referring to the orthogonal transformation maximum size identification information parsed from the bitstream.

Here, in the simple inverse orthogonal transformation, in a case where the encoding circuit 23 has skipped the output of residual data in simple orthogonal transformation, the encoding circuit 23 skips inverse orthogonal transformation on the coding unit having the size larger than the threshold of the orthogonal transformation maximum size. Thus, in this case, a simple transformation coefficient from the image encoding apparatus 12 includes no residual data, and inverse orthogonal transformation is substantially not performed. Here, irrespective of the parsing of residual identification information for identifying whether residual data is included in the simple transformation coefficient, the encoding circuit 23 can determine, by referring to the orthogonal transformation maximum size identification information, that no residual data is included in the simple transformation coefficient in the case where the size of the coding unit is larger than the threshold of the orthogonal transformation maximum size.

Alternatively, in the simple inverse orthogonal transformation, in a case where the encoding circuit 23 has skipped orthogonal transformation in simple orthogonal transformation, the encoding circuit 23 skips inverse orthogonal transformation on the coding unit having the size larger than the threshold of the orthogonal transformation maximum size and outputs residual data in the spatial domain not subjected to orthogonal transformation. Thus, in this case, the image decoding apparatus 13 can perform decoding by using, without any change, the residual data in the spatial domain not subjected to orthogonal transformation that is included in the simple transformation coefficient from the image encoding apparatus 12.

Alternatively, in the simple inverse orthogonal transformation, in a case where the encoding circuit 23 has output only a direct-current component as residual data in simple orthogonal transformation, the encoding circuit 23 does not perform inverse orthogonal transformation on the coding unit having the size larger than the threshold of the orthogonal transformation maximum size and outputs the direct-current component. Thus, in this case, the image decoding apparatus 13 can perform decoding by using, without any change, the direct-current component serving as the residual data and included in the simple transformation coefficient from the image encoding apparatus 12. Note that, in the case where decoding is performed by using a direct-current component serving as residual data, for example, it is expected that the image quality is enhanced as compared to a case where decoding is performed without using residual data.

<Configuration Example of Image Encoding Apparatus>

FIG. 4 is a block diagram illustrating a configuration example of one embodiment of the image encoding apparatus to which the present technology is applied.

The image encoding apparatus 12 illustrated in FIG. 4 is an apparatus configured to encode the image data of moving images. For example, the image encoding apparatus 12 implements the technology described in NPL 1, NPL 2, or NPL 3 and encodes the image data of moving images by a method compliant with the standards described in any of those pieces of literature.

Note that, FIG. 4 illustrates main processing sections, main data flows, and the like and may not illustrate everything. That is, the image encoding apparatus 12 may include processing sections not illustrated as blocks in FIG. 4, or there may be processing or data flows not indicated by the arrows or the like in FIG. 4.

As illustrated in FIG. 4, the image encoding apparatus 12 includes a control section 101, a reorder buffer 111, a calculation section 112, an orthogonal transformation section 113, a quantization section 114, an encoding section 115, an accumulation buffer 116, an inverse quantization section 117, an inverse orthogonal transformation section 118, a calculation section 119, an in-loop filter section 120, a frame memory 121, a prediction section 122, and a rate control section 123. Note that, the prediction section 122 includes an intra prediction section and an inter prediction section, which are not illustrated. The image encoding apparatus 12 is an apparatus for generating encoded data (bitstream) by encoding moving image data.

<Control Section>

The control section 101 divides moving image data held by the reorder buffer 111 into blocks of processing units (CUs, PUs, transformation blocks, or the like) on the basis of a block size in processing units specified externally or in advance. Further, the control section 101 determines, on the basis of, for example, RDO (Rate-Distortion Optimization), encoding parameters (header information Hinfo, prediction mode information Pinfo, transformation information Tinfo, filter information Finfo, and the like) to be supplied to the corresponding blocks.

The details of these encoding parameters are described later. When having determined the encoding parameters as described above, the control section 101 supplies the encoding parameters to the corresponding blocks. The specific description is given below.

The header information Hinfo is supplied to each block.

The prediction mode information Pinfo is supplied to the encoding section 115 and the prediction section 122.

The transformation information Tinfo is supplied to the encoding section 115, the orthogonal transformation section 113, the quantization section 114, the inverse quantization section 117, and the inverse orthogonal transformation section 118.

The filter information Finfo is supplied to the in-loop filter section 120.

Moreover, when setting the processing unit, as described above with reference to FIG. 2, the control section 101 can set orthogonal transformation maximum size identification information for identifying a threshold of an orthogonal transformation maximum size. Then, the control section 101 also supplies the orthogonal transformation maximum size identification information to the encoding section 115.

<Reorder Buffer>

To the image encoding apparatus 12, the fields of moving image data (input images) are input in the order of reproduction (the order of display). The reorder buffer 111 acquires and holds (stores) the input images in the order of reproduction (the order of display). The reorder buffer 111 reorders the input images in the order of encoding (the order of decoding) or divides the input images into blocks of processing units, under control of the control section 101. The reorder buffer 111 supplies each processed input image to the calculation section 112. Further, the reorder buffer 111 also supplies each input image (original image) to the prediction section 122 and the in-loop filter section 120.

<Calculation Section>

The calculation section 112 receives an image I corresponding to a block in processing units and a predicted image P supplied from the prediction section 122 and subtracts the predicted image P from the image I, to derive the predicted residual D (D=I−P). The calculation section 112 supplies the derived predicted residual D to the orthogonal transformation section 113.

<Orthogonal Transformation Section>

The orthogonal transformation section 113 receives the predicted residual D supplied from the calculation section 112 and the transformation information Tinfo supplied from the control section 101, and performs orthogonal transformation on the predicted residual D on the basis of the transformation information Tinfo, to thereby derive the transformation coefficient Coeff. The orthogonal transformation section 113 supplies the thus obtained transformation coefficient Coeff to the quantization section 114.

Here, as described above with reference to FIG. 2, the orthogonal transformation section 113 can perform orthogonal transformation or simple orthogonal transformation on the basis of the size of a coding unit by referring to a threshold of an orthogonal transformation maximum size. Then, in the case where the orthogonal transformation section 113 performs orthogonal transformation, the orthogonal transformation section 113 supplies, to the quantization section 114, the transformation coefficient Coeff generated in the processing.

Meanwhile, in the case where the orthogonal transformation section 113 performs simple orthogonal transformation, as described above with reference to FIG. 2, the orthogonal transformation section 113 skips the output of residual data, supplies residual data in the spatial domain to the quantization section 114 as a simple transformation coefficient, or supplies only a direct-current component serving as residual data to the quantization section 114 as a simple transformation coefficient.

<Quantization Section>

The quantization section 114 receives the transformation coefficient Coeff supplied from the orthogonal transformation section 113 and the transformation information Tinfo supplied from the control section 101, and scales (quantizes) the transformation coefficient Coeff on the basis of the transformation information Tinfo. Note that, the rate of this quantization is controlled by the rate control section 123. The quantization section 114 supplies the quantized transformation coefficient obtained by such quantization, namely, a quantized transformation coefficient level “level” to the encoding section 115 and the inverse quantization section 117.

<Encoding Section>

The encoding section 115 receives the quantized transformation coefficient level “level” supplied from the quantization section 114, the various encoding parameters (header information Hinfo, prediction mode information Pinfo, transformation information Tinfo, filter information Finfo, and the like) supplied from the control section 101, information associated with filters such as filter coefficients supplied from the in-loop filter section 120, and information associated with an optimum prediction mode and supplied from the prediction section 122. The encoding section 115 performs variable length encoding (for example, arithmetic coding) on the quantized transformation coefficient level “level” to generate a bit string (encoded data).

Further, the encoding section 115 derives residual information Rinfo from the quantized transformation coefficient level “level” and encodes the residual information Rinfo, to generate a bit string.

Moreover, the encoding section 115 puts the information associated with the filters, which is supplied from the in-loop filter section 120, in the filter information Finfo, and puts the information associated with the optimum prediction mode, which is supplied from the prediction section 122, in the prediction mode information Pinfo. Then, the encoding section 115 encodes the above-mentioned various encoding parameters (header information Hinfo, prediction mode information Pinfo, transformation information Tinfo, filter information Finfo, and the like) to generate a bit string.

Further, the encoding section 115 multiplexes the bit string of the various types of information generated as described above, to generate encoded data. The encoding section 115 supplies the encoded data to the accumulation buffer 116.

In addition, the encoding section 115 can encode orthogonal transformation maximum size identification information supplied from the control section 101 to generate a bit string and can multiplex the bit string to generate encoded data. With this, as described above with reference to FIG. 1, the encoded data (bitstream) including the orthogonal transformation maximum size identification information is transmitted.

<Accumulation Buffer>

The accumulation buffer 116 temporarily holds encoded data obtained by the encoding section 115. The accumulation buffer 116 outputs, at a predetermined timing, the encoded data held, to the outside of the image encoding apparatus 12 as a bit stream, for example. For example, this encoded data is transmitted to the decoding side through any recording medium, any transmission medium, or any information processing apparatus. That is, the accumulation buffer 116 is also a transmission section configured to transmit encoded data (bitstream).

<Inverse Quantization Section>

The inverse quantization section 117 performs processing for inverse quantization. For example, the inverse quantization section 117 receives the quantized transformation coefficient level “level” supplied from the quantization section 114 and the transformation information Tinfo supplied from the control section 101, and scales (inversely quantizes) the value of the quantized transformation coefficient level “level” on the basis of the transformation information Tinfo. Note that, this inverse quantization is processing reverse to quantization that is performed in the quantization section 114. The inverse quantization section 117 supplies a transformation coefficient Coeff_IQ obtained by such inverse quantization to the inverse orthogonal transformation section 118.

<Inverse Orthogonal Transformation Section>

The inverse orthogonal transformation section 118 performs processing for inverse orthogonal transformation. For example, the inverse orthogonal transformation section 118 receives the transformation coefficient Coeff_IQ supplied from the inverse quantization section 117 and the transformation information Tinfo supplied from the control section 101, and performs inverse orthogonal transformation on the transformation coefficient Coeff_IQ on the basis of the transformation information Tinfo, to thereby derive a predicted residual D′. Note that, this inverse orthogonal transformation is processing reverse to orthogonal transformation that is performed in the orthogonal transformation section 113. The inverse orthogonal transformation section 118 supplies the predicted residual D′ obtained by such inverse orthogonal transformation to the calculation section 119. Note that, since the inverse orthogonal transformation section 118 is similar to an inverse orthogonal transformation section on the decoding side (described later), a description on the decoding side (given later) is applicable to the inverse orthogonal transformation section 118.

<Calculation Section>

The calculation section 119 receives the predicted residual D′ supplied from the inverse orthogonal transformation section 118 and the predicted image P supplied from the prediction section 122. The calculation section 119 adds the predicted residual D′ to the predicted image P corresponding to the predicted residual D′, to thereby derive a locally decoded image R_{local} (R_{local}=D′+P). The calculation section 119 supplies the derived locally decoded image R_{local} to the in-loop filter section 120 and the frame memory 121.

<In-Loop Filter Section>

The in-loop filter section 120 performs processing for in-loop filtering. For example, the in-loop filter section 120 receives the locally decoded image R_{local} supplied from the calculation section 119, the filter information Finfo supplied from the control section 101, and input images (original images) supplied from the reorder buffer 111. Note that, the in-loop filter section 120 receives any freely-selected information and may receive information other than these pieces of information. For example, as necessary, information regarding prediction modes, motion information, code amount target values, a quantization parameter QP, picture types, or blocks (CUs, CTUs, or the like) may be input to the in-loop filter section 120.

The in-loop filter section 120 appropriately filters the locally decoded image R_{local} on the basis of the filter information Finfo. The in-loop filter section 120 uses, as necessary, the input images (original images) or other types of input information in filtering.

For example, as described in NPL 1, the in-loop filter section 120 applies four in-loop filters, namely, a bilateral filter, a deblocking filter (DBF), an adaptive offset filter (SAO (Sample Adaptive Offset)), and an adaptive loop filter (ALF), in this order. Note that, which filter is applied and the order of filters are freely determined and can appropriately be selected.

Needless to say, the in-loop filter section 120 performs any type of filtering, and the examples described above are not limitative. For example, the in-loop filter section 120 may apply a wiener filter or the like.

The in-loop filter section 120 supplies the filtered locally decoded image R_{local} to the frame memory 121. Note that, for example, in a case where information associated with the filters such as the filter coefficients is transmitted to the decoding side, the in-loop filter section 120 supplies the information associated with the filters to the encoding section 115.

<Frame Memory>

The frame memory 121 performs processing for storage of data of images. For example, the frame memory 121 receives and holds (stores) the locally decoded image R_{local} supplied from the calculation section 119 and the filtered locally decoded image R_{local} supplied from the in-loop filter section 120. Further, the frame memory 121 reconstructs a decoded image R in picture units by using the locally decoded image R_{local} and holds the decoded image R (stores the decoded image R in the buffer in the frame memory 121). The frame memory 121 supplies, in response to a request from the prediction section 122, the decoded image R (or part thereof) to the prediction section 122.

<Prediction Section>

The prediction section 122 performs processing for generation of predicted images. For example, the prediction section 122 receives the prediction mode information Pinfo supplied from the control section 101, input images (original images) supplied from the reorder buffer 111, and the decoded image R (or part thereof) read out from the frame memory 121. The prediction section 122 performs prediction processing such as inter prediction or intra prediction by using the prediction mode information Pinfo and an input image (original image) and performs prediction by referring to the decoded image R as a reference image. The prediction section 122 performs motion compensation on the basis of the prediction result, to generate the predicted image P. The prediction section 122 supplies the generated predicted image P to the calculation section 112 and the calculation section 119. Further, the prediction section 122 supplies information associated with a prediction mode selected in the processing described above, namely, an optimum prediction mode, to the encoding section 115 as necessary.

<Rate Control Section>

The rate control section 123 performs processing for rate control. For example, the rate control section 123 controls, on the basis of the code amount of encoded data accumulated in the accumulation buffer 116, the quantization operation rate of the quantization section 114 so that neither overflow nor underflow occurs.

In the image encoding apparatus 12 having the configuration described above, the control section 101 sets orthogonal transformation maximum size identification information for identifying a threshold of an orthogonal transformation maximum size. Further, the orthogonal transformation section 113 performs orthogonal transformation or simple orthogonal transformation on the basis of the size of a coding unit by referring to the threshold of the orthogonal transformation maximum size. Then, the encoding section 115 encodes a transformation coefficient or a simple transformation coefficient obtained by performance of orthogonal transformation or simple orthogonal transformation, to thereby generate encoded data including the orthogonal transformation maximum size identification information. Thus, with orthogonal transformation maximum size identification information set so that a threshold of an orthogonal transformation maximum size takes a small value, for example, the image encoding apparatus 12 performs simple orthogonal transformation on a coding unit having a large size, with the result that the processing amount of encoding can be reduced.

Note that, the processing processes performed in the encoding circuit 23 as the setting section, the orthogonal transformation section, and the encoding section, which have been described above with reference to FIG. 2, may not be performed separately in the respective blocks illustrated in FIG. 4 and may each be performed in a plurality of blocks, for example.

<Configuration Example of Image Decoding Apparatus>

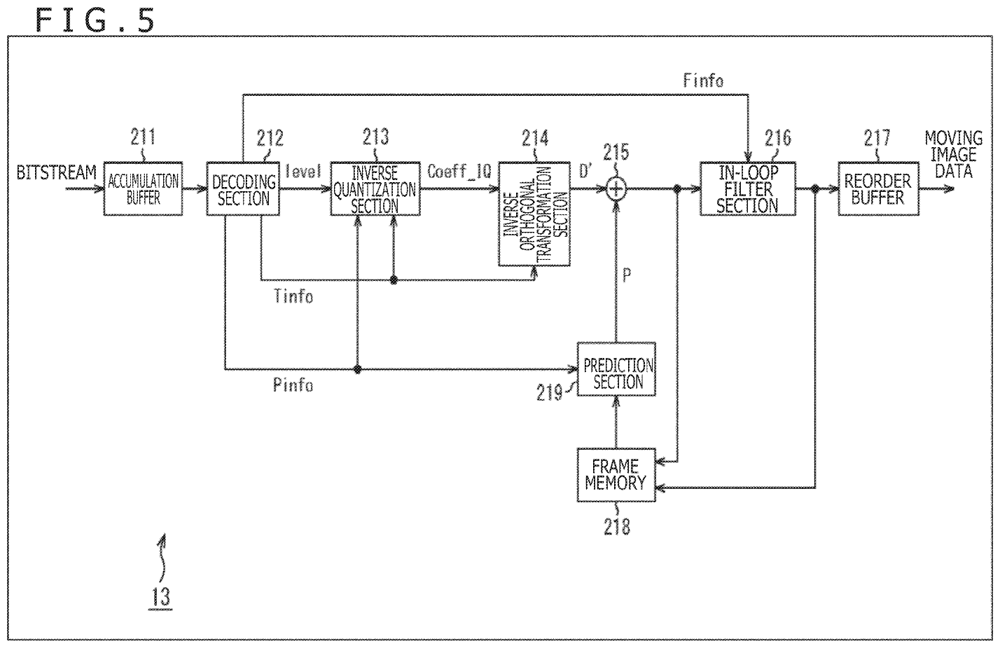

FIG. 5 is a block diagram illustrating a configuration example of one embodiment of the image decoding apparatus to which the present technology is applied. The image decoding apparatus 13 illustrated in FIG. 5 is an apparatus configured to decode encoded data that is an encoded predicted residual between an image and the corresponding predicted image, such as AVC or HEVC. For example, the image decoding apparatus 13 implements the technology described in NPL 1, NPL 2, or NPL 3, and decodes encoded data that is the image data of moving images encoded by a method compliant with the standards described in any of those pieces of literature. For example, the image decoding apparatus 13 decodes encoded data (bitstream) generated by the image encoding apparatus 12 described above.

Note that, FIG. 5 illustrates main processing sections, main data flows, and the like and may not illustrate everything. That is, the image decoding apparatus 13 may include processing sections not illustrated as blocks in FIG. 5, or there may be processing or data flows not indicated by the arrows or the like in FIG. 5.

In FIG. 5, the image decoding apparatus 13 includes an accumulation buffer 211, a decoding section 212, an inverse quantization section 213, an inverse orthogonal transformation section 214, a calculation section 215, an in-loop filter section 216, a reorder buffer 217, a frame memory 218, and a prediction section 219. Note that, the prediction section 219 includes an intra prediction section and an inter prediction section, which are not illustrated. The image decoding apparatus 13 is an apparatus for generating moving image data by decoding encoded data (bitstream).

<Accumulation Buffer>

The accumulation buffer 211 acquires and holds (stores) a bitstream input to the image decoding apparatus 13. The accumulation buffer 211 supplies the accumulated bitstream to the decoding section 212 at a predetermined timing or in a case where predetermined conditions are satisfied, for example.

<Decoding Section>

The decoding section 212 performs processing for image decoding. For example, the decoding section 212 receives a bitstream supplied from the accumulation buffer 211 and performs variable length decoding on the syntax value of each syntax element from the bit string according to the definition of a syntax table, to thereby derive parameters.

The parameters derived from the syntax elements and the syntax values of the syntax elements include, for example, information such as the header information Hinfo, the prediction mode information Pinfo, the transformation information Tinfo, the residual information Rinfo, and the filter information Finfo. That is, the decoding section 212 parses (analyzes and acquires) these pieces of information from the bitstream. These pieces of information are described below.

<Header Information Hinfo>

The header information Hinfo includes, for example, header information such as VPS (Video Parameter Set), SPS (Sequence Parameter Set), PPS (Picture Parameter Set), or SH (slice header). The header information Hinfo includes, for example, information for defining an image size (horizontal width PicWidth and vertical width PicHeight), a bit depth (luma bitDepthY and chroma bitDepthC), a chroma array type ChromaArrayType, a maximum value MaxCUSize/minimum value MinCUSize of a CU size, a maximum depth MaxQTDepth/minimum depth MinQTDepth of quad-tree partition, a maximum depth MaxBTDepth/minimum depth MinBTDepth of binary-tree partition, a maximum value MaxTSSize of a transformation skip block (also referred to as a “maximum transformation skip block size”), or an on/off flag (also referred to as an “enabled flag”) of each encoding tool.

Examples of the on/off flag of an encoding tool included in the header information Hinfo include on/off flags for transformation and quantization described below. Note that, the on/off flag of an encoding tool is also interpretable as a flag indicating whether or not syntax for the encoding tool is present in encoded data. Further, in a case where the value of the on/off flag is 1 (true), it indicates that the encoding tool is available, and in a case where the value of the on/off flag is 0 (false), it indicates that the encoding tool is unavailable. Note that, the interpretation of the flag values may be reversed.

A cross-component prediction enabled flag (ccp_enabled_flag) is flag information indicating whether or not cross-component prediction (also referred to as “CCP” or “CC prediction”) is available. For example, in a case where this flag information is “1” (true), it indicates availability. In a case where this flag information is “0” (false), it indicates unavailability.

Note that, this CCP is also referred to as “cross-component linear prediction (CCLM or CCLMP).”

<Prediction Mode Information Pinfo>

The prediction mode information Pinfo includes, for example, information such as size information PBSize regarding a PB (prediction block) to be processed (prediction block size), intra prediction mode information IPinfo, and motion prediction information MVinfo.

The intra prediction mode information IPinfo includes, for example, prev_intra_luma_pred_flag, mpm_idx, rem_intra_pred_mode, and a luma intra prediction mode IntraPredModeY derived from the syntax thereof in JCTVC-W1005, 7.3.8.5 Coding Unit syntax.

Further, the intra prediction mode information IPinfo includes, for example, a cross-component prediction flag (ccp_flag (cclmp_flag)), a multi-class linear prediction mode flag (mclm_flag), a chroma sample location type identifier (chroma_sample_loc_type_idx), a chroma MPM identifier (chroma_mpm_idx), and a luma intra prediction mode (IntraPredModeC) derived from the syntax thereof.

The cross-component prediction flag (ccp_flag (cclmp_flag)) is flag information indicating whether or not cross-component linear prediction is to be applied. For example, when ccp_flag==1, it indicates that cross-component prediction is to be applied. When ccp_flag==0, it indicates that cross-component prediction is not to be applied.

The multi-class linear prediction mode flag (mclm_flag) is information associated with a linear prediction mode (linear prediction mode information). More specifically, the multi-class linear prediction mode flag (mclm_flag) is flag information indicating whether or not a multi-class linear prediction mode is to be set. For example, in a case where the flag is “0,” it indicates a 1-class mode (single-class mode) (for example, CCLMP). In a case where the flag is “1,” it indicates a 2-class mode (multi-class mode) (for example, MCLMP).

The chroma sample location type identifier (chroma_sample_loc_type_idx) is an identifier for identifying the type of the pixel location of a chroma component (also referred to as a “chroma sample location type”). For example, in a case where the chroma array type (ChromaArrayType) that is information associated with a color format indicates a 420 format, the chroma sample location type identifier is allocated in the following manner.

chroma_sample_loc_type_idx==0: Type 2

chroma_sample_loc_type_idx==1: Type 3

chroma_sample_loc_type_idx==2: Type 0

chroma_sample_loc_type_idx==3: Type 1

Note that, this chroma sample location type identifier (chroma_sample_loc_type_idx) is transmitted as (or by being stored in) information associated with the pixel location of a chroma component (chroma_sample_loc_info( )).

The chroma MPM identifier (chroma_mpm_idx) is an identifier indicating which prediction mode candidate in a chroma intra prediction mode candidate list (intraPredModeCandListC) is specified as the chroma intra prediction mode.

The motion prediction information MVinfo includes, for example, information such as merge_idx, merge_flag, inter_pred_idc, ref_idx_LX, mvp_lX_flag, X={0,1}, and mvd (see, for example, JCTVC-W1005, 7.3.8.6 Prediction Unit Syntax).

Needless to say, the prediction mode information Pinfo includes any freely-selected information and may include information other than these pieces of information.

<Transformation Information Tinfo>

The transformation information Tinfo includes, for example, the following information. Needless to say, the transformation information Tinfo includes any freely-selected information and may include information other than these pieces of information.

Horizontal width size TBWSize and vertical width TBHSize (or logarithmic values log 2TBWSize and log 2TBHSize of TBWSize and TBHSize each having 2 as the base) of a transformation block to be processed

Transformation skip flag (ts_flag): a flag indicating whether or not to skip (inverse) primary transformation and (inverse) secondary transformation

Scan identifier (scanIdx)

Quantization parameter (qp)

Quantization matrix (scaling_matrix (for example, JCTVC-W1005, 7.3.4 Scaling list data syntax))

<Residual Information Rinfo>

The residual information Rinfo (see, for example, 7.3.8.11 Residual Coding syntax of JCTVC-W1005) includes, for example, the following syntax.

cbf (coded_block_flag): a residual data presence/absence flag

last_sig_coeff_x_pos: a last non-zero coefficient X coordinate

last_sig_coeff_y_pos: a last non-zero coefficient Y coordinate

coded_sub_block_flag: a subblock non-zero coefficient presence/absence flag

sig_coeff_flag: a non-zero coefficient presence/absence flag

gr1_flag: a flag indicating whether the level of a non-zero coefficient is larger than 1 (also referred to as a “GR1 flag”)

gr2_flag: a flag indicating whether the level of a non-zero coefficient is larger than 2 (also referred to as a “GR2 flag”)

sign_flag: a sign indicating whether a non-zero coefficient is positive or negative (also referred to as a “sign”)

coeff_abs_level_remaining: a remaining level of a non-zero coefficient (also referred to as a “non-zero coefficient remaining level”), etc.

Needless to say, the residual information Rinfo includes any freely-selected information and may include information other than these pieces of information.

<Filter Information Finfo>

The filter information Finfo includes, for example, control information associated with each filter processing process described below.

Control information associated with a deblocking filter (DBF)

Control information associated with a pixel adaptive offset (SAO)

Control information associated with an adaptive loop filter (ALF)

Control information associated with other linear/non-linear filters

More specifically, the filter information Finfo includes, for example, information for specifying a picture or a region in the picture to which each filter is applied, filter on/off control information in CU units, and filter on/off control information associated with slice or tile boundaries. Needless to say, the filter information Finfo includes any freely-selected information and may include information other than these pieces of information.

Returning to the description of the decoding section 212, the decoding section 212 derives, by referring to the residual information Rinfo, the quantized transformation coefficient level “level” at each coefficient position in each transformation block. The decoding section 212 supplies the quantized transformation coefficient level “level” to the inverse quantization section 213.

Further, the decoding section 212 supplies the parsed header information Hinfo, prediction mode information Pinfo, quantized transformation coefficient level “level” transformation information Tinfo, and filter information Finfo to the corresponding blocks. The specific description is given below.

The header information Hinfo is supplied to the inverse quantization section 213, the inverse orthogonal transformation section 214, the prediction section 219, and the in-loop filter section 216.

The prediction mode information Pinfo is supplied to the inverse quantization section 213 and the prediction section 219.

The transformation information Tinfo is supplied to the inverse quantization section 213 and the inverse orthogonal transformation section 214.

The filter information Finfo is supplied to the in-loop filter section 216.

Needless to say, the above-mentioned examples are mere examples, and the examples are not limitative. For example, each encoding parameter may be supplied to any processing section.

Further, other types of information may be supplied to any processing section.

Moreover, in the case where orthogonal transformation maximum size identification information for identifying a threshold of an orthogonal transformation maximum size is included in a bitstream, the decoding section 212 can parse the orthogonal transformation maximum size identification information. Further, the decoding section 212 can decode the bitstream to generate a transformation coefficient or a simple transformation coefficient by orthogonal transformation or simple orthogonal transformation.

<Inverse Quantization Section>

The inverse quantization section 213 performs processing for inverse quantization. For example, the inverse quantization section 213 receives the transformation information Tinfo and the quantized transformation coefficient level “level” supplied from the decoding section 212, and scales (inversely quantizes) the value of the quantized transformation coefficient level “level” on the basis of the transformation information Tinfo, to thereby derive the inversely-quantized transformation coefficient Coeff_IQ.

Note that, this inverse quantization is performed as processing reverse to quantization by the quantization section 114. Further, this inverse quantization is processing similar to inverse quantization by the inverse quantization section 117. That is, the inverse quantization section 117 performs processing similar to the processing by the inverse quantization section 213 (inverse quantization).

The inverse quantization section 213 supplies the derived transformation coefficient Coeff_IQ to the inverse orthogonal transformation section 214.

<Inverse Orthogonal Transformation Section>

The inverse orthogonal transformation section 214 performs processing for inverse orthogonal transformation. For example, the inverse orthogonal transformation section 214 receives the transformation coefficient Coeff_IQ supplied from the inverse quantization section 213 and the transformation information Tinfo supplied from the decoding section 212, and performs inverse orthogonal transformation on the transformation coefficient Coeff_IQ on the basis of the transformation information Tinfo, to thereby derive the predicted residual D′.

Note that, this inverse orthogonal transformation is performed as processing reverse to orthogonal transformation by the orthogonal transformation section 113. Further, this inverse orthogonal transformation is processing similar to inverse orthogonal transformation by the inverse orthogonal transformation section 118. That is, the inverse orthogonal transformation section 118 performs processing similar to the processing by the inverse orthogonal transformation section 214 (inverse orthogonal transformation).

The inverse orthogonal transformation section 214 supplies the derived predicted residual D′ to the calculation section 215.

Here, as described above with reference to FIG. 3, the inverse orthogonal transformation section 214 can perform inverse orthogonal transformation or simple inverse orthogonal transformation on a transformation coefficient or a simple transformation coefficient on the basis of the size of a coding unit by referring to orthogonal transformation maximum size identification information parsed by the decoding section 212 from a bitstream. Then, in the case where the inverse orthogonal transformation section 214 performs inverse orthogonal transformation, the inverse orthogonal transformation section 214 supplies, to the calculation section 215, the predicted residual D′ generated by performance of inverse orthogonal transformation on the transformation coefficient Coeff_IQ.

On the other hand, in the case where the inverse orthogonal transformation section 214 performs simple inverse orthogonal transformation, the inverse orthogonal transformation section 214 does not perform inverse orthogonal transformation on the simple transformation coefficient obtained by simple orthogonal transformation and skips the supply of residual data to the calculation section 215. Alternatively, the inverse orthogonal transformation section 214 skips inverse orthogonal transformation on the simple transformation coefficient obtained by simple orthogonal transformation and supplies, without any change, residual data in the spatial domain included in the simple transformation coefficient to the calculation section 215. Alternatively, the inverse orthogonal transformation section 214 skips inverse orthogonal transformation on the simple transformation coefficient obtained by simple orthogonal transformation and supplies, to the calculation section 215, only a direct-current component serving as residual data included in the simple transformation coefficient.

<Calculation Section>

The calculation section 215 performs processing for addition of information regarding images. For example, the calculation section 215 receives the predicted residual D′ supplied from the inverse orthogonal transformation section 214 and the predicted image P supplied from the prediction section 219. The calculation section 215 adds the predicted residual D′ to the predicted image P (predicted signal) corresponding to the predicted residual D′, to thereby derive the locally decoded image R_{local} (R_{local}=D′+P).

The calculation section 215 supplies the derived locally decoded image R_{local} to the in-loop filter section 216 and the frame memory 218.

<In-Loop Filter Section>

The in-loop filter section 216 performs processing for in-loop filtering. For example, the in-loop filter section 216 receives the locally decoded image R_{local} supplied from the calculation section 215 and the filter information Finfo supplied from the decoding section 212. Note that, the in-loop filter section 216 receives any freely-selected information and may receive information other than these pieces of information.

The in-loop filter section 216 appropriately filters the locally decoded image R_{local} on the basis of the filter information Finfo.

For example, as described in NPL 1, the in-loop filter section 216 applies four in-loop filters, namely, a bilateral filter, a deblocking filter (DBF), an adaptive offset filter (SAO (Sample Adaptive Offset)), and an adaptive loop filter (ALF), in this order. Note that, which filter is applied and the order of filters are freely determined and can appropriately be selected.

The in-loop filter section 216 performs filtering corresponding to filtering that is performed on the encoding side (for example, the in-loop filter section 120 of the image encoding apparatus 12 of FIG. 4).

Needless to say, the in-loop filter section 216 performs any type of filtering, and the examples described above are not limitative. For example, the in-loop filter section 216 may apply a wiener filter or the like.

The in-loop filter section 216 supplies the filtered locally decoded image R_{local} to the reorder buffer 217 and the frame memory 218.

<Reorder Buffer>

The reorder buffer 217 receives and holds (stores) the locally decoded image R_{local} supplied from the in-loop filter section 216. The reorder buffer 217 reconstructs the decoded image R in picture units by using the locally decoded image R_{local} and holds the decoded image R (stores the decoded image R in the buffer). The reorder buffer 217 reorders the obtained decoded images R from the order of decoding to the order of reproduction. The reorder buffer 217 outputs, as moving image data, the group of reordered decoded images R to the outside of the image decoding apparatus 13.

<Frame Memory>

The frame memory 218 performs processing for storage of data of images. For example, the frame memory 218 receives the locally decoded image R_{local} supplied from the calculation section 215, to reconstruct the decoded image R in picture units, and stores the decoded image R in the buffer in the frame memory 218.

Further, the frame memory 218 receives the in-loop filtered locally decoded image R_{local} supplied from the in-loop filter section 216, to reconstruct the decoded image R in picture units, and stores the decoded image R in the buffer in the frame memory 218. The frame memory 218 appropriately supplies the stored decoded image R (or part thereof) to the prediction section 219 as a reference image.

Note that, the frame memory 218 may store the header information Hinfo, the prediction mode information Pinfo, the transformation information Tinfo, the filter information Finfo, and the like, which are used in the generation of decoded images.

<Prediction Section>

The prediction section 219 performs processing for generation of predicted images. For example, the prediction section 219 receives the prediction mode information Pinfo supplied from the decoding section 212 and performs prediction by a prediction method specified by the prediction mode information Pinfo, to thereby derive the predicted image P. When deriving the predicted image P, the prediction section 219 uses, as a reference image, the pre-filtered or filtered decoded image R (or part thereof) stored in the frame memory 218 and specified by the prediction mode information Pinfo. The prediction section 219 supplies the derived predicted image P to the calculation section 215.

In the image decoding apparatus 13 having the configuration described above, the decoding section 212 performs the parse processing of parsing orthogonal transformation maximum size identification information from a bitstream, and decodes the bitstream to generate a transformation coefficient or a simple transformation coefficient. Further, the inverse orthogonal transformation section 214 performs inverse orthogonal transformation or inverse simple orthogonal transformation on the transformation coefficient or the simple transformation coefficient on the basis of the size of a coding unit by referring to the orthogonal transformation maximum size identification information. Thus, in a case where orthogonal transformation maximum size identification information is set so that a threshold of an orthogonal transformation maximum size takes a small value, the image decoding apparatus 13 performs, for example, simple inverse orthogonal transformation on a coding unit having a large size, with the result that the processing amount of decoding can be reduced.

Note that, the processing processes performed in the decoding circuit 33 as the parsing section, the decoding section, and the inverse orthogonal transformation section, which have been described above with reference to FIG. 3, may not be performed separately in the respective blocks illustrated in FIG. 5 and may each be performed in a plurality of blocks, for example.

<Image Encoding and Image Decoding>

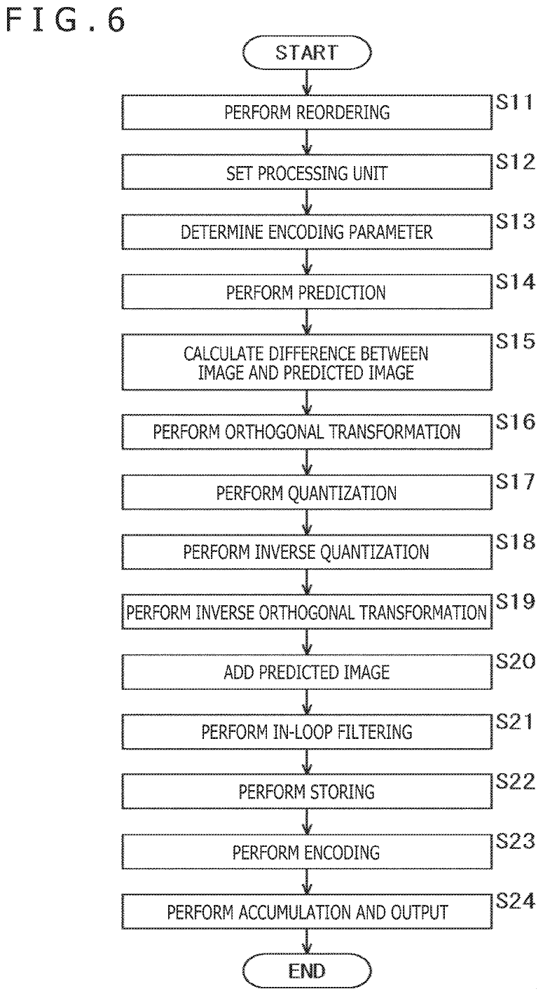

With reference to the flowcharts of FIG. 6 to FIG. 13, image encoding that is executed by the image encoding apparatus 12 and image decoding that is executed by the image decoding apparatus 13 are described.

FIG. 6 is a flowchart illustrating image encoding that is executed by the image encoding apparatus 12.

When image encoding starts, in Step S11, the reorder buffer 111 reorders the frame order of input moving image data from the order of display to the order of encoding, under the control of the control section 101.

In Step S12, the control section 101 sets a processing unit to the input image held by the reorder buffer 111 (performs block division). Here, when the processing unit is set, the processing of setting orthogonal transformation maximum size identification information is also performed.

In Step S13, the control section 101 determines (sets) encoding parameters for the input image held by the reorder buffer 111.

In Step S14, the prediction section 122 performs prediction to generate a predicted image or the like in an optimum prediction mode. For example, in this prediction, the prediction section 122 performs intra prediction to generate a predicted image or the like in an optimum intra prediction mode and performs inter prediction to generate a predicted image or the like in an optimum inter prediction mode. The prediction section 122 selects, from those predicted images, an optimum prediction mode on the basis of a cost function value or the like.

In Step S15, the calculation section 112 calculates a difference between the input image and the predicted image in the optimum mode selected in the prediction in Step S14. That is, the calculation section 112 generates the predicted residual D between the input image and the predicted image. The data amount of the thus obtained predicted residual D is smaller than that of the original image data. Thus, as compared to a case where an image is encoded as it is, the data amount can be reduced.

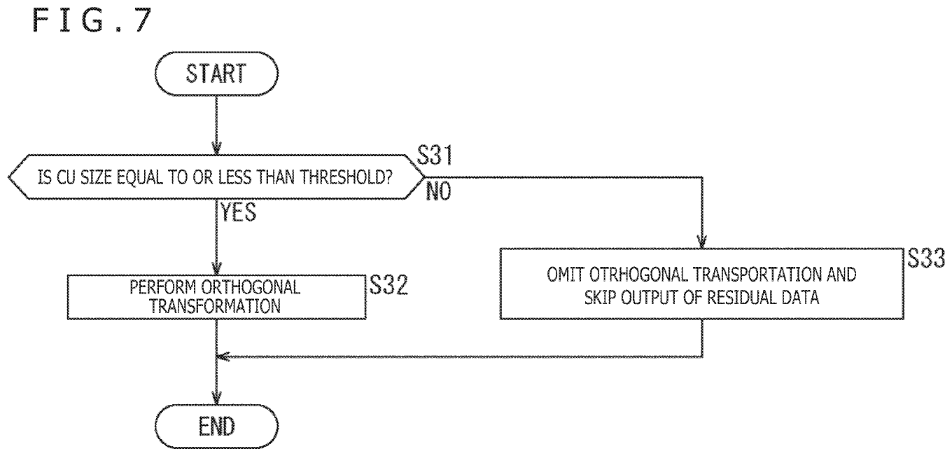

In Step S16, the orthogonal transformation section 113 performs orthogonal transformation on the predicted residual D generated in the processing in Step S15, to thereby derive the transformation coefficient Coeff. Here, as described later with reference to FIG. 7 to FIG. 9, the orthogonal transformation section 113 can perform, instead of orthogonal transformation, simple orthogonal transformation on the basis of the size of the coding unit by referring to the threshold of the orthogonal transformation maximum size.

In Step S17, the quantization section 114 quantizes, by using, for example, quantization parameters calculated by the control section 101, the transformation coefficient Coeff obtained in the processing in Step S16, to thereby derive the quantized transformation coefficient level “level.”

In Step S18, the inverse quantization section 117 inversely quantizes the quantized transformation coefficient level “level” generated in the processing in Step S17 with characteristics corresponding to the characteristics of the quantization in Step S17, to thereby derive the transformation coefficient Coeff_IQ.

In Step S19, the inverse orthogonal transformation section 118 performs inverse orthogonal transformation on the transformation coefficient Coeff_IQ obtained in the processing in Step S18 by a method corresponding to the orthogonal transformation in Step S16, to thereby derive the predicted residual D′. Note that, since this inverse orthogonal transformation is similar to inverse orthogonal transformation that is performed on the decoding side (described later), a description on the decoding side (given later) is applicable to this inverse orthogonal transformation in Step S19.

In Step S20, the calculation section 119 adds the predicted image obtained in the prediction in Step S14 to the predicted residual D′ derived in the processing in Step S19, to thereby generate a decoded image locally decoded.

In Step S21, the in-loop filter section 120 performs in-loop filtering on the locally decoded image derived in the processing in Step S20.

In Step S22, the frame memory 121 stores the locally decoded image derived in the processing in Step S20 and the locally decoded image filtered in Step S21.

In Step S23, the encoding section 115 encodes the quantized transformation coefficient level “level” obtained in the processing in Step S17. For example, the encoding section 115 encodes the quantized transformation coefficient level “level” which is information regarding the image, by arithmetic coding or the like, to thereby generate encoded data. Moreover, here, the encoding section 115 encodes the various encoding parameters (header information Hinfo, prediction mode information Pinfo, and transformation information Tinfo). Further, the encoding section 115 derives the residual information RInfo from the quantized transformation coefficient level “level” and encodes the residual information RInfo.

In Step S24, the accumulation buffer 116 accumulates the thus obtained encoded data and outputs the encoded data to the outside of the image encoding apparatus 12 as a bitstream, for example. This bitstream is transmitted to the decoding side through, for example, a transmission path or a recording medium. Further, the rate control section 123 performs rate control as necessary.

When the processing in Step S24 ends, the image encoding ends.

In the image encoding having the flow as described above, as the processing in Step S12 and Step S16, the above-mentioned processing to which the present technology is applied is performed. Thus, with this image encoding, simple orthogonal transformation is performed in the case where the size of a coding unit is large so that the processing amount of the image encoding can be reduced.

FIG. 7 is a flowchart illustrating a first processing example of processing in the case where simple orthogonal transformation is performed in Step S16 of FIG. 6.

In Step S31, the orthogonal transformation section 113 determines whether or not the size of the coding unit is equal to or less than the threshold of the orthogonal transformation maximum size.

In a case where the orthogonal transformation section 113 determines in Step S31 that the size of the coding unit is equal to or less than the threshold of the orthogonal transformation maximum size, the processing proceeds to Step S32. In Step S32, the orthogonal transformation section 113 performs orthogonal transformation on the predicted residual D and supplies the transformation coefficient Coeff generated in the processing in question to the quantization section 114. Then, the processing ends.

On the other hand, in a case where the orthogonal transformation section 113 determines in Step S31 that the size of the coding unit is not equal to or less than the threshold of the orthogonal transformation maximum size (is larger than the orthogonal transformation maximum size), the processing proceeds to Step S33. In Step S33, the orthogonal transformation section 113 does not perform orthogonal transformation and skips the supply of residual data to the quantization section 114. Then, the processing ends.

As described above, in the case where the size of a coding unit is larger than an orthogonal transformation maximum size, the orthogonal transformation section 113 can bypass orthogonal transformation on the coding unit and skip the output of residual data.

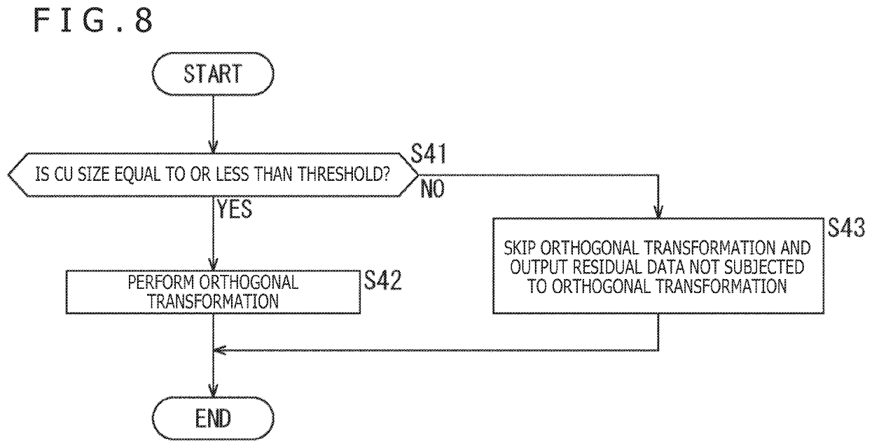

FIG. 8 is a flowchart illustrating a second processing example of processing in the case where simple orthogonal transformation is performed in Step S16 of FIG. 6.

In Step S41, the orthogonal transformation section 113 determines whether or not the size of the coding unit is equal to or less than the threshold of the orthogonal transformation maximum size.

In a case where the orthogonal transformation section 113 determines in Step S41 that the size of the coding unit is equal to or less than the threshold of the orthogonal transformation maximum size, the processing proceeds to Step S42. In Step S42, the orthogonal transformation section 113 performs orthogonal transformation on the predicted residual D and supplies the transformation coefficient Coeff generated in the processing in question to the quantization section 114. Then, the processing ends.

On the other hand, in a case where the orthogonal transformation section 113 determines in Step S41 that the size of the coding unit is not equal to or less than the threshold of the orthogonal transformation maximum size (is larger than the orthogonal transformation maximum size), the processing proceeds to Step S43. In Step S43, the orthogonal transformation section 113 skips orthogonal transformation and supplies residual data in the spatial domain not subjected to orthogonal transformation to the quantization section 114. Then, the processing ends.

As described above, in the case where the size of a coding unit is larger than an orthogonal transformation maximum size, the orthogonal transformation section 113 can skip orthogonal transformation on the coding unit and output residual data in the spatial domain.

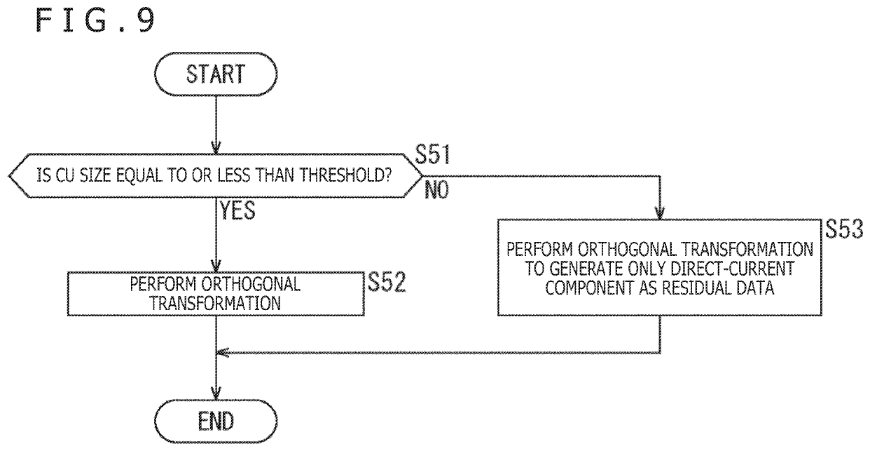

FIG. 9 is a flowchart illustrating a third processing example of processing in the case where simple orthogonal transformation is performed in Step S16 of FIG. 6.

In Step S51, the orthogonal transformation section 113 determines whether or not the size of the coding unit is equal to or less than the threshold of the orthogonal transformation maximum size.

In a case where the orthogonal transformation section 113 determines in Step S51 that the size of the coding unit is equal to or less than the threshold of the orthogonal transformation maximum size, the processing proceeds to Step S52. In Step S52, the orthogonal transformation section 113 performs orthogonal transformation on the predicted residual D and supplies the transformation coefficient Coeff generated in the processing in question to the quantization section 114. Then, the processing ends.

On the other hand, in a case where the orthogonal transformation section 113 determines in Step S51 that the size of the coding unit is not equal to or less than the threshold of the orthogonal transformation maximum size (is larger than the orthogonal transformation maximum size), the processing proceeds to Step S53. In Step S53, the orthogonal transformation section 113 performs inverse orthogonal transformation to generate only a direct-current component as residual data and supplies the direct-current component to the quantization section 114. Then, the processing ends.

As described above, in the case where the size of a coding unit is larger than an orthogonal transformation maximum size, the orthogonal transformation section 113 can output only a direct-current component as residual data of orthogonal transformation on the coding unit.

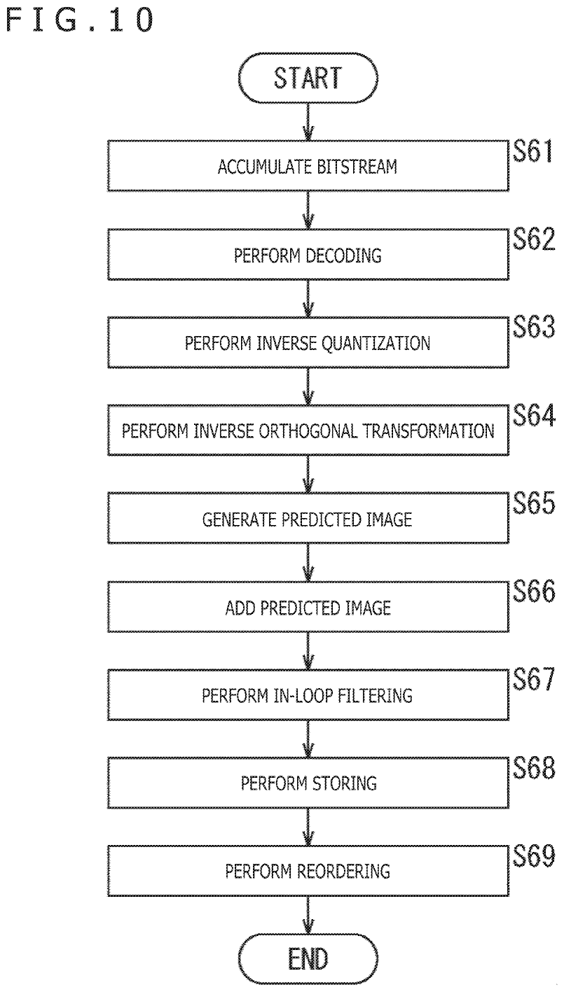

FIG. 10 is a flowchart illustrating image decoding that is executed by the image decoding apparatus 13.

When image decoding starts, in Step S61, the accumulation buffer 211 acquires and holds (accumulates) encoded data (bitstream) supplied from the outside of the image decoding apparatus 13.

In Step S62, the decoding section 212 decodes the encoded data (bitstream) to obtain the quantized transformation coefficient level “level.” Further, the decoding section 212 parses (analyzes and acquires) various encoding parameters from the encoded data (bitstream) by this decoding. Here, when decoding is performed, as described above with reference to FIG. 3, the processing of parsing orthogonal transformation maximum size identification information from the bitstream is also performed. Further, the various encoding parameters obtained by decoding includes a transformation coefficient or a simple transformation coefficient as the result of orthogonal transformation or simple orthogonal transformation.

In Step S63, the inverse quantization section 213 performs, on the quantized transformation coefficient level “level” obtained in the processing in Step S62, inverse quantization that is processing reverse to quantization, which is performed on the encoding side, to thereby obtain the transformation coefficient Coeff_IQ.

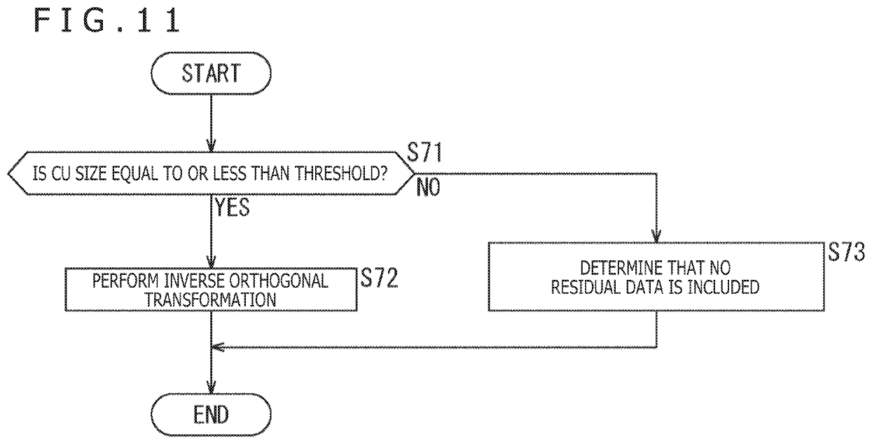

In Step S64, the inverse orthogonal transformation section 214 performs, on the transformation coefficient Coeff_IQ obtained in the processing in Step S63, inverse orthogonal transformation that is processing reverse to orthogonal transformation, which is performed on the encoding side, to thereby obtain the predicted residual D′. Here, as described later with reference to FIG. 11 to FIG. 13, the inverse orthogonal transformation section 214 can perform, instead of inverse orthogonal transformation, simple inverse orthogonal transformation on the basis of the size of the coding unit by referring to the orthogonal transformation maximum size identification information.

In Step S65, the prediction section 219 executes, on the basis of the information parsed in Step S62, prediction with a prediction method specified by the encoding side, and generates the predicted image P by referring to a reference image stored in the frame memory 218, for example.

In Step S66, the calculation section 215 adds the predicted residual D′ obtained in the processing in Step S64 to the predicted image P obtained in the processing in Step S65, to thereby derive the locally decoded image R_{local}.

In Step S67, the in-loop filter section 216 performs in-loop filtering on the locally decoded image R_{local} obtained in the processing in Step S66.

In Step S68, the reorder buffer 217 derives the decoded image R by using the filtered locally decoded image R_{local} obtained in the processing in Step S67 and reorders the order of the group of decoded images R from the order of decoding to the order of reproduction. The group of decoded images R reordered in the order of reproduction is output to the outside of the image decoding apparatus 13 as a moving image.

Further, in Step S69, the frame memory 218 stores at least one of the locally decoded image R_{local} obtained in the processing in Step S66 or the filtered locally decoded image R_{local} obtained in the processing in Step S67.

When the processing in Step S69 ends, the image decoding ends.

In the image decoding having the flow as described above, as the processing in Step S62 and Step S64, the above-mentioned processing to which the present technology is applied is performed. Thus, with this image decoding, simple inverse orthogonal transformation is performed in the case where the size of a coding unit is large, so that the processing amount of image decoding can be reduced.

FIG. 11 is a flowchart illustrating a first processing example of processing in the case where simple inverse orthogonal transformation is performed in Step S64 of FIG. 10.

In Step S71, the inverse orthogonal transformation section 214 determines whether or not the size of the coding unit is equal to or less than the threshold of the orthogonal transformation maximum size.

In a case where the inverse orthogonal transformation section 214 determines in Step S71 that the size of the coding unit is equal to or less than the threshold of the orthogonal transformation maximum size, the processing proceeds to Step S72. In Step S72, the inverse orthogonal transformation section 214 supplies, to the calculation section 215, the predicted residual D′ obtained by performance of inverse orthogonal transformation on the transformation coefficient Coeff_IQ. Then, the processing ends.

On the other hand, in a case where the inverse orthogonal transformation section 214 determines in Step S71 that the size of the coding unit is not equal to or less than the threshold of the orthogonal transformation maximum size (is larger than the orthogonal transformation maximum size), the processing proceeds to Step S73. In Step S73, the inverse orthogonal transformation section 214 determines, irrespective of the parsing of residual identification information for identifying whether residual data is included in the simple transformation coefficient, that no residual data is included in the simple transformation coefficient. Then, the processing ends without inverse orthogonal transformation being performed.

As described above, in the case where the size of a coding unit is larger than an orthogonal transformation maximum size, the inverse orthogonal transformation section 214 can skip inverse orthogonal transformation on the coding unit.

In Step S71, the inverse orthogonal transformation section 214 determines whether or not the size of the coding unit is equal to or less than the threshold of the orthogonal transformation maximum size.

In a case where the inverse orthogonal transformation section 214 determines in Step S71 that the size of the coding unit is equal to or less than the threshold of the orthogonal transformation maximum size, the processing proceeds to Step S72. In Step S72, the inverse orthogonal transformation section 214 supplies, to the calculation section 215, the predicted residual D′ obtained by performance of inverse orthogonal transformation on the transformation coefficient Coeff_IQ. Then, the processing ends.

Meanwhile, in a case where the inverse orthogonal transformation section 214 determines in Step S71 that the size of the coding unit is not equal to or less than the threshold of the orthogonal transformation maximum size (is larger than the orthogonal transformation maximum size), the processing proceeds to Step S73. In Step S73, the inverse orthogonal transformation section 214 determines, irrespective of the parsing of residual identification information for identifying whether residual data is included in the simple transformation coefficient, that no residual data is included in the simple transformation coefficient. Thus, the inverse orthogonal transformation section 214 does not perform inverse orthogonal transformation and skips the supply of residual data from the inverse orthogonal transformation section 214 to the calculation section 215. Then, the processing ends. That is, in this case, the calculation section 215 reconstructs the image without adding the predicted residual to the predicted image.

As described above, in the case where the size of a coding unit is larger than an orthogonal transformation maximum size, the inverse orthogonal transformation section 214 can skip inverse orthogonal transformation on the coding unit.

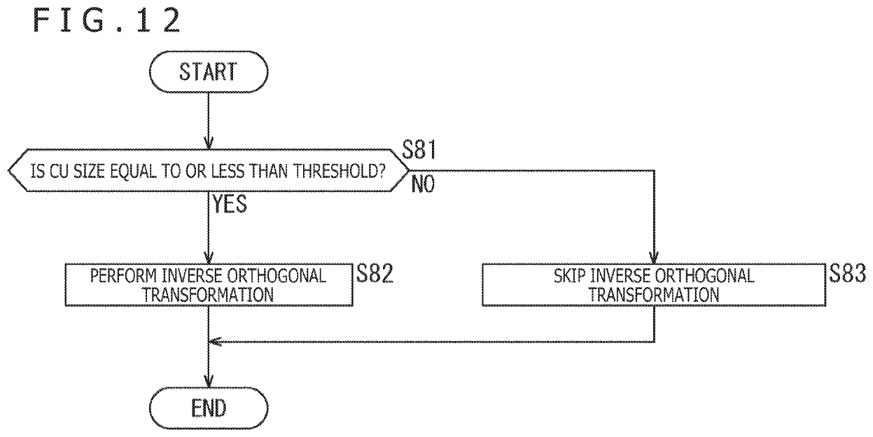

FIG. 12 is a flowchart illustrating a second processing example of processing in the case where simple inverse orthogonal transformation is performed in Step S64 of FIG. 10.

In Step S81, the inverse orthogonal transformation section 214 determines whether or not the size of the coding unit is equal to or less than the threshold of the orthogonal transformation maximum size.

In a case where the inverse orthogonal transformation section 214 determines in Step S81 that the size of the coding unit is equal to or less than the threshold of the orthogonal transformation maximum size, the processing proceeds to Step S82. In Step S82, the inverse orthogonal transformation section 214 supplies, to the calculation section 215, the predicted residual D′ obtained by performance of inverse orthogonal transformation on the transformation coefficient Coeff_IQ. Then, the processing ends.

On the other hand, in a case where the inverse orthogonal transformation section 214 determines in Step S81 that the size of the coding unit is not equal to or less than the threshold of the orthogonal transformation maximum size (is larger than the orthogonal transformation maximum size), the processing proceeds to Step S83. In Step S83, the inverse orthogonal transformation section 214 skips inverse orthogonal transformation and supplies, without any change, residual data in the spatial domain included in the simple transformation coefficient to the calculation section 215. Then, the processing ends. That is, in this case, the calculation section 215 can reconstruct the image only by adding the residual data to the predicted image.

As described above, in the case where the size of a coding unit is larger than an orthogonal transformation maximum size, the inverse orthogonal transformation section 214 can skip inverse orthogonal transformation on the coding unit.

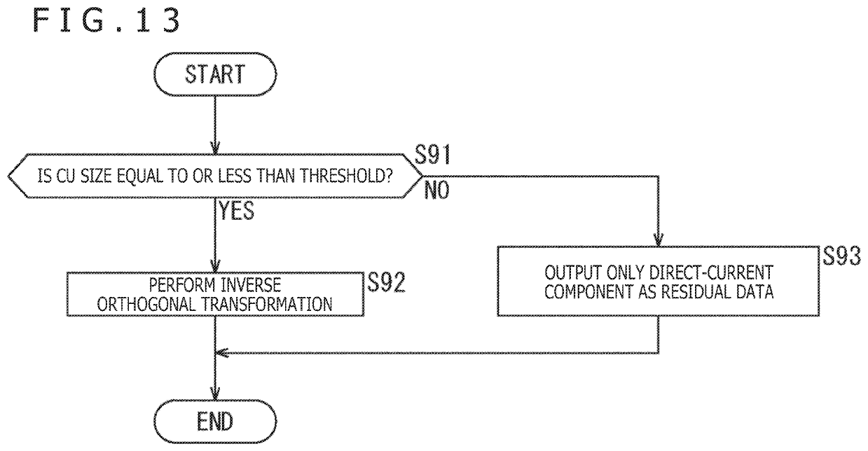

FIG. 13 is a flowchart illustrating a third processing example of processing in the case where simple inverse orthogonal transformation is performed in Step S64 of FIG. 10.

In Step S91, the inverse orthogonal transformation section 214 determines whether or not the size of the coding unit is equal to or less than the threshold of the orthogonal transformation maximum size.

In a case where the inverse orthogonal transformation section 214 determines in Step S91 that the size of the coding unit is equal to or less than the threshold of the orthogonal transformation maximum size, the processing proceeds to Step S92. In Step S92, the inverse orthogonal transformation section 214 supplies, to the calculation section 215, the predicted residual D′ obtained by performance of inverse orthogonal transformation on the transformation coefficient Coeff_IQ. Then, the processing ends.

On the other hand, in a case where the inverse orthogonal transformation section 214 determines in Step S91 that the size of the coding unit is not equal to or less than the threshold of the orthogonal transformation maximum size (is larger than the orthogonal transformation maximum size), the processing proceeds to Step S93. In Step S93, the inverse orthogonal transformation section 214 supplies, to the calculation section 215, a direct-current component serving as residual data included in the simple transformation coefficient, without performing inverse orthogonal transformation. Then, the processing ends. That is, in this case, the calculation section 215 can reconstruct the image only by adding the direct-current component to the predicted image.

As described above, in the case where the size of a coding unit is larger than an orthogonal transformation maximum size, the inverse orthogonal transformation section 214 can output a direct-current component serving as residual data without performing inverse orthogonal transformation on the coding unit.

<Configuration Example of Computer>

Next, the series of processing processes described above can be performed by means of hardware or software. In the case where the series of processing processes is performed by means of software, a program configuring the software is installed in a general-purpose computer or the like.

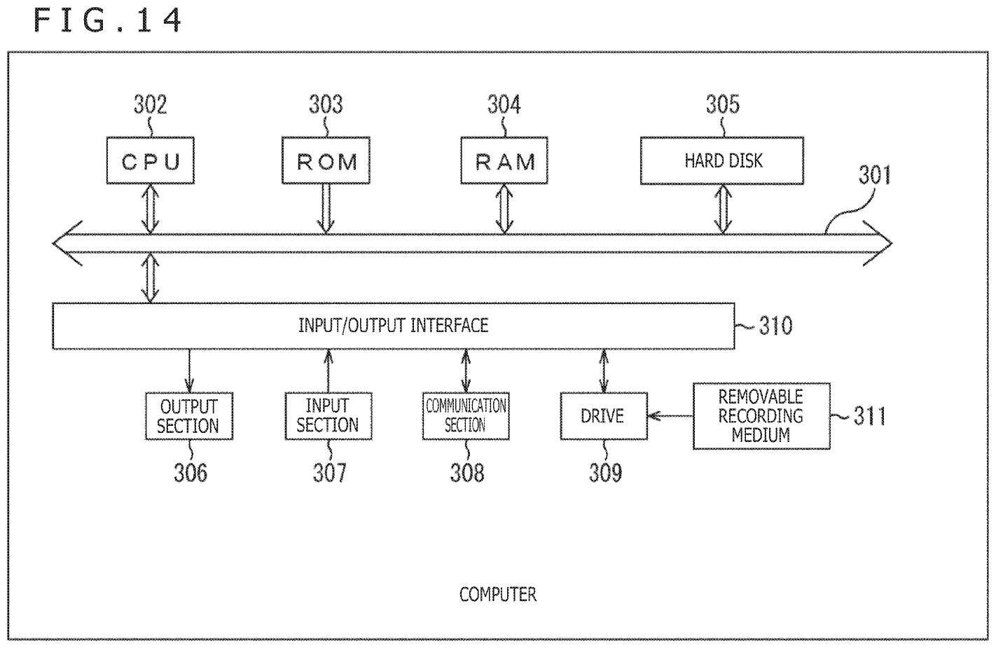

FIG. 14 is a block diagram illustrating a configuration example of one embodiment of a computer having installed therein a program for executing the series of processing processes described above.

The program can be recorded in advance on a hard disk 305 or a ROM 303 serving as a recording medium installed in the computer.

Alternatively, the program can be stored (recorded) in a removable recording medium 311 that is driven by a drive 309. The removable recording medium 311 can be provided as what is generally called package software. Here, examples of the removable recording medium 311 include a flexible disk, a CD-ROM (Compact Disc Read Only Memory), an MO (Magneto Optical) disk, a DVD (Digital Versatile Disc), a magnetic disk, and a semiconductor memory.

Note that, while the program can be installed in the computer from the removable recording medium 311 as described above, the program can be downloaded to the computer via a communication network or a broadcast network, to be installed in the internal hard disk 305. Specifically, the program can be wirelessly transferred from a download site to the computer via an artificial satellite for digital satellite broadcasting or can be transferred to the computer via a network such as a LAN (Local Area Network) or the Internet in a wired manner.

The computer includes an internal CPU (Central Processing Unit) 302, and an input/output interface 310 is connected to the CPU 302 via a bus 301.

The CPU 302 executes a program stored in the ROM (Read Only Memory) 303 according to a command input through the input/output interface 310 when the user operates an input section 307 or the like. Alternatively, the CPU 302 loads a program stored in the hard disk 305 onto a RAM (Random Access Memory) 304 and executes the program.

With this, the CPU 302 performs the processing according to the above-mentioned flowcharts or the processing performed by the configurations of the above-mentioned block diagrams. Then, if necessary, the CPU 302 controls an output section 306 to output the processing result via, for example, the input/output interface 310, controls a communication section 308 to transmit the processing result, or records the processing result in the hard disk 305.

Note that, the input section 307 includes a keyboard, a mouse, a microphone, or the like. Further, the output section 306 includes an LCD (Liquid Crystal Display), a speaker, or the like.

Here, in the present specification, the processing that the computer performs in accordance with the program is not necessarily performed chronologically in the order described in the flowcharts. That is, the processing that the computer performs in accordance with the program includes processing processes that are executed in parallel or individually as well (for example, parallel processing or object-based processing).

Further, the program may be processed by a single computer (processor) or shared and processed by plural computers. Moreover, the program may be transferred to a computer at a remote site to be executed.

Moreover, a system herein means a set of plural components (apparatuses, modules (parts), or the like), and it does not matter whether or not all the components are in a single housing. Thus, plural apparatuses that are accommodated in separate housings and connected to each other via a network and a single apparatus in which plural modules are accommodated in a single housing are both systems.

Further, for example, the configuration described as a single apparatus (or processing section) may be divided to be configured as plural apparatuses (or processing sections). In contrast, the configurations described above as plural apparatuses (or processing sections) may be combined to be configured as a single apparatus (or processing section). Moreover, needless to say, a configuration other than the above-mentioned configurations may be added to the configuration of each apparatus (or each processing section). Further, part of the configuration of a certain apparatus (or processing section) may be included in the configuration of another apparatus (or another processing section) as long as the configuration and operation as the entire system are substantially unchanged.

Further, for example, the present technology can take the configuration of cloud computing in which one function is shared and processed by plural apparatuses via a network.

Further, for example, the program described above can be executed by any apparatus. In that case, it is sufficient if the apparatus has necessary functions (functional blocks or the like) and can thus obtain necessary information.

Further, the respective steps described in the flowcharts described above can be executed by a single apparatus or shared and executed by plural apparatuses. Moreover, in a case where plural processing processes are included in one step, the plural processing processes included in one step can be executed by a single apparatus or shared and executed by plural apparatuses. In other words, plural processing processes included in one step can be executed as processing in plural steps. In contrast, the processing processes described as plural steps can be executed collectively as one step.

Note that, as for the program that is to be executed by the computer, the processing processes in the steps describing the program may be executed chronologically in the order described herein or in parallel. Alternatively, the processing of the program may be executed at a right timing, for example, when the program is called. That is, unless there is any contradiction, the processing processes in the respective steps may be executed in an order different from the order described above. Moreover, the processing processes in the steps describing the program may be executed in parallel with the processing processes of another program or may be executed in combination with the processing processes of another program.

Note that, the plural present technologies described herein can be implemented independently of each other or solely unless there is any contradiction. Needless to say, the plural present technologies can be implemented in any combination. For example, the whole or part of the present technology described in any of the embodiments can be implemented in combination with the whole or part of the present technology described in another embodiment. Further, the whole or part of any of the present technologies described above can be implemented in combination with another technology not described above.

<Field of Application of Present Technology>

The present technology is applicable to any image encoding and decoding system. That is, various types of processing for image encoding or decoding, such as transformation (inverse transformation), quantization (inverse quantization), encoding (decoding), and prediction, may have any specification unless there is any contradiction to the above-mentioned present technology, and the examples described above are not limitative. Further, the processing may partly be omitted unless there is any contradiction to the above-mentioned present technology.

Further, the present technology is applicable to multiview image encoding/decoding systems configured to encode/decode multiview images each including images of a plurality of viewpoints (views). In that case, the present technology may be applied to the encoding/decoding of each viewpoint (view).

Moreover, the present technology is applicable to hierarchical image encoding (scalable encoding)/decoding systems configured to encode/decode hierarchical images each having a plurality of layers (hierarchies) so that a predetermined parameter has a scalability function. In that case, the present technology may be applied to the encoding/decoding of each hierarchy (layer).

The image encoding apparatus and image decoding apparatus according to the embodiments are applicable to various electronic apparatuses, for example, transmitters or receivers for satellite broadcasting, wired broadcasting such as a cable TV, distribution on the Internet, or distribution to terminals through cellular communication (for example, television receivers or cell phones), or apparatuses configured to record images on media, such as optical discs, magnetic disks, or flash memories, or to reproduce images from the foregoing storage media (for example, hard disk recorders or cameras).

Further, the present technology can also be implemented as any kind of configuration that is installed in any apparatus or an apparatus of a system, for example, a processor serving as a system LSI (Large Scale Integration) or the like (for example, video processor), a module that uses a plurality of processors or the like (for example, video module), a unit that uses a plurality of modules or the like (for example, video unit), or a set that includes other additional functions in addition to a unit (that is, a configuration of part of an apparatus) (for example, video set).

Furthermore, the present technology is also applicable to a network system including a plurality of apparatuses. For example, the present technology is also applicable to a cloud service for providing an image (moving image)-related service to any terminal such as computers, AV (Audio Visual) equipment, portable information processing terminals, or IoT (Internet of Things) devices.

Note that, systems, apparatuses, processing sections, and the like to which the present technology is applied can be used in any field, for example, transportation, medical care, crime prevention, agriculture, the livestock industry, the mining industry, beauty care, factories, home electronics, weather, or natural surveillance. Further, such systems, apparatuses, processing sections, and the like can be used for any purpose.

For example, the present technology is applicable to systems or devices used for providing viewing content or the like. Moreover, for example, the present technology is also applicable to systems or devices used for transportation such as traffic conditions management or automatic operation. Further, for example, the present technology is also applicable to systems or devices used for security. Further, for example, the present technology is also applicable to systems or devices used for the automatic control of machines or the like. Further, for example, the present technology is also applicable to systems or devices used for agriculture or the livestock industry. Moreover, for example, the present technology is also applicable to systems or devices used for monitoring the state of nature such as volcanoes, forests, or oceans, wildlife, or the like. Furthermore, for example, the present technology is also applicable to systems or devices used for sports.

<Combination Example of Configurations>

Note that, the present technology can also take the following configurations.

(1)

An image encoding apparatus including:

a setting section configured to set identification information for identifying a threshold of an orthogonal transformation maximum size that is a maximum size of a processing unit in orthogonal transformation of an image;

an orthogonal transformation section configured to perform, in a case where a coding unit that is a processing unit in encoding of the image is larger than the threshold of the orthogonal transformation maximum size, simple orthogonal transformation on the coding unit; and

an encoding section configured to encode a simple transformation coefficient that is a result of the simple orthogonal transformation by the orthogonal transformation section, to thereby generate a bitstream including the identification information.

(2)

The image encoding apparatus according to Item (1), in which

the setting section sets, in a case where a processing amount required for an application for executing encoding of the image or decoding of the bitstream is equal to or less than a predetermined setting value, the identification information so that the threshold of the orthogonal transformation maximum size takes a small value.

(3)

The image encoding apparatus according to Item (1) or (2), in which,

in the simple orthogonal transformation, the orthogonal transformation section skips output of residual data with respect to the coding unit having a size larger than the threshold of the orthogonal transformation maximum size.

(4)

The image encoding apparatus according to Item (1) or (2), in which,

in the simple orthogonal transformation, the orthogonal transformation section skips orthogonal transformation on the coding unit having a size larger than the threshold of the orthogonal transformation maximum size.

(5)

The image encoding apparatus according to Item (1) or (2), in which,

in the simple orthogonal transformation, the orthogonal transformation section generates residual data including only a direct-current component as the simple transformation coefficient for the coding unit having a size larger than the threshold of the orthogonal transformation maximum size.

(6)

An image encoding method including:

by an encoding apparatus configured to encode an image,

setting identification information for identifying a threshold of an orthogonal transformation maximum size that is a maximum size of a processing unit in orthogonal transformation of the image;

performing, in a case where a coding unit that is a processing unit in encoding of the image is larger than the threshold of the orthogonal transformation maximum size, simple orthogonal transformation on the coding unit; and

encoding a simple transformation coefficient that is a result of the simple orthogonal transformation, to thereby generate a bitstream including the identification information.

(7)

An image decoding apparatus including:

a parsing section configured to parse, from a bitstream including identification information for identifying a threshold of an orthogonal transformation maximum size that is a maximum size of a processing unit in orthogonal transformation of an image, the identification information;

a decoding section configured to decode the bitstream to generate a simple transformation coefficient that is a result of simple orthogonal transformation on a coding unit that is a processing unit in encoding of the image; and

an inverse orthogonal transformation section configured to perform simple inverse orthogonal transformation on the simple transformation coefficient based on a size of the coding unit by referring to the identification information parsed by the parsing section.

(8)

The image decoding apparatus according to Item (7), in which,

in the simple inverse orthogonal transformation, the inverse orthogonal transformation section determines, irrespective of parsing of residual identification information for identifying whether residual data is included in the simple transformation coefficient, that no residual data is included in the simple transformation coefficient of the coding unit in a case where the size of the coding unit is larger than the threshold of the orthogonal transformation maximum size.

(9)

The image decoding apparatus according to Item (7), in which,

in the simple inverse orthogonal transformation, the inverse orthogonal transformation section skips, in a case where the size of the coding unit is larger than the threshold of the orthogonal transformation maximum size, inverse orthogonal transformation on the simple transformation coefficient that is output without performance of orthogonal transformation on the coding unit.

(10)

The image decoding apparatus according to Item (7), in which,

in the simple inverse orthogonal transformation, the inverse orthogonal transformation section outputs, in a case where the size of the coding unit is larger than the threshold of the orthogonal transformation maximum size, a direct-current component serving as residual data included in the simple transformation coefficient of the coding unit.

(11)

An image decoding method including:

by a decoding apparatus configured to decode an image,

parsing, from a bitstream including identification information for identifying a threshold of an orthogonal transformation maximum size that is a maximum size of a processing unit in orthogonal transformation of the image, the identification information;

decoding the bitstream to generate a simple transformation coefficient that is a result of simple orthogonal transformation on a coding unit that is a processing unit in encoding of the image; and

performing simple inverse orthogonal transformation on the simple transformation coefficient, based on a size of the coding unit by referring to the identification information parsed.

Note that, the present embodiment is not limited to the embodiments described above, and various modifications can be made without departing from the gist of the present disclosure. Further, the effects described herein are mere examples and are not limited, and other effects may be provided.

### REFERENCE SIGNS LIST

11 Image processing system, 12 Image encoding apparatus, 13 Image decoding apparatus, 21 Image processing chip, 22 External memory, 23 Encoding circuit, 24 Cache memory, 31 Image processing chip, 32 External memory, 33 Decoding circuit, 34 Cache memory, 101 Control section, 122 Prediction section, 113 Orthogonal transformation section, 115 Encoding section, 118 Inverse orthogonal transformation section, 120 In-loop filter section, 212 Decoding section, 214 Inverse orthogonal transformation section, 216 In-loop filter section, 219 Prediction section

1. An image encoding apparatus comprising:
a setting section configured to set identification information for identifying a threshold of an orthogonal transformation maximum size that is a maximum size of a processing unit in orthogonal transformation of an image;
an orthogonal transformation section configured to perform, in a case where a coding unit that is a processing unit in encoding of the image is larger than the threshold of the orthogonal transformation maximum size, simple orthogonal transformation on the coding unit; and
an encoding section configured to encode a simple transformation coefficient that is a result of the simple orthogonal transformation by the orthogonal transformation section, to thereby generate a bitstream including the identification information.

2. The image encoding apparatus according to claim 1, wherein
the setting section sets, in a case where a processing amount required for an application for executing encoding of the image or decoding of the bitstream is equal to or less than a predetermined setting value, the identification information so that the threshold of the orthogonal transformation maximum size takes a small value.

3. The image encoding apparatus according to claim 1, wherein,
in the simple orthogonal transformation, the orthogonal transformation section skips output of residual data with respect to the coding unit having a size larger than the threshold of the orthogonal transformation maximum size.

4. The image encoding apparatus according to claim 1, wherein,
in the simple orthogonal transformation, the orthogonal transformation section skips orthogonal transformation on the coding unit having a size larger than the threshold of the orthogonal transformation maximum size.

5. The image encoding apparatus according to claim 1, wherein,
in the simple orthogonal transformation, the orthogonal transformation section generates residual data including only a direct-current component as the simple transformation coefficient for the coding unit having a size larger than the threshold of the orthogonal transformation maximum size.

6. An image encoding method comprising:
by an encoding apparatus configured to encode an image,
setting identification information for identifying a threshold of an orthogonal transformation maximum size that is a maximum size of a processing unit in orthogonal transformation of the image;
performing, in a case where a coding unit that is a processing unit in encoding of the image is larger than the threshold of the orthogonal transformation maximum size, simple orthogonal transformation on the coding unit; and
encoding a simple transformation coefficient that is a result of the simple orthogonal transformation, to thereby generate a bitstream including the identification information.

7. An image decoding apparatus comprising:
a parsing section configured to parse, from a bitstream including identification information for identifying a threshold of an orthogonal transformation maximum size that is a maximum size of a processing unit in orthogonal transformation of an image, the identification information;
a decoding section configured to decode the bitstream to generate a simple transformation coefficient that is a result of simple orthogonal transformation on a coding unit that is a processing unit in encoding of the image; and
an inverse orthogonal transformation section configured to perform simple inverse orthogonal transformation based on a size of the coding unit by referring to the identification information parsed by the parsing section.

8. The image decoding apparatus according to claim 7, wherein,
in the simple inverse orthogonal transformation, the inverse orthogonal transformation section determines, irrespective of parsing of residual identification information for identifying whether residual data is included in the simple transformation coefficient, that no residual data is included in the simple transformation coefficient of the coding unit in a case where the size of the coding unit is larger than the threshold of the orthogonal transformation maximum size.

9. The image decoding apparatus according to claim 7, wherein,
in the simple inverse orthogonal transformation, the inverse orthogonal transformation section skips, in a case where the size of the coding unit is larger than the threshold of the orthogonal transformation maximum size, inverse orthogonal transformation on the simple transformation coefficient that is output without performance of orthogonal transformation on the coding unit.

10. The image decoding apparatus according to claim 7, wherein,
in the simple inverse orthogonal transformation, the inverse orthogonal transformation section outputs, in a case where the size of the coding unit is larger than the threshold of the orthogonal transformation maximum size, a direct-current component serving as residual data included in the simple transformation coefficient of the coding unit.

11. An image decoding method comprising:
by a decoding apparatus configured to decode an image,
parsing, from a bitstream including identification information for identifying a threshold of orthogonal transformation maximum size that is a maximum size of a processing unit in orthogonal transformation of the image, the identification information;
decoding the bitstream to generate a simple transformation coefficient that is a result of simple orthogonal transformation on a coding unit that is a processing unit in encoding of the image; and
performing simple inverse orthogonal transformation based on a size of the coding unit by referring to the identification information parsed.
